(19) United States
(12) Patent Application Publication
(10) Pub. No.: US 2006/0095385 A1
(43) Pub. Date: May 4, 2006

(54) Method and network for selectively controlling the utility a target

(76) Inventors: Paul Atkinson, San Diego, CA (US); Ronald S. Conero, San Diego, CA (US)

Correspondence Address: WILLIAM J. KOLEGRAFF, 3119 TURNBERRY WAY, JAMUL, CA, 91935, US

(21) Appl. No.: 11/259,185

(22) Filed: Oct. 26, 2005

Related U.S. Application Data
(60) Provisional application No. 60/622,137, filed on Oct. 26, 2004.
(60) Provisional application No. 60/633,971, filed on Dec. 7, 2004.
(60) Provisional application No. 60/654,384, filed on Feb. 18, 2005.

(51) Int. Cl. H04L 9/00

(52) U.S. Cl. 705/64

(57) ABSTRACT

A distribution control system is provided to support the controlled and selective changing of utility for a target. The target with controlled utility may be an electronic device, or alternatively, may be a tangible media, such as an optical disc. The distribution control system has a target with a change effecting device and a restricted access key. An activation device retrieves or generates an authorization key, and sends the authorization key to the target. The authorization key may be sent to the target wirelessly, for example, using a radio frequency signal. The target has logic that uses the restricted access key and the authorization key to change the utility of the target. In one example, the activation device retrieves the authorization key from a network operation center (NOC) by sending a target identifier to the NOC, and the NOC retrieves the authorization key for the identified target. The activation device may also connect to other systems for obtaining approval to change the utility of the target. For example, the authorization key may be sent to the target upon receiving payment, password, or other confirmation.

### RELATED APPLICATIONS

The present application claims priority to U.S. provisional patent application 60/622,137, filed Oct. 26, 2004, entitled “A Method and System for Affecting the Utility of a Target”; to U.S. provisional patent application 60/633,971, filed Dec. 7, 2004, entitled “A Method and Means of RF Activation of a Target”; and to U.S. provisional patent application 60/654,384, filed Feb. 18, 2005, entitled “A Method and Means of RF Activation of a Target”, all of which are incorporated herein by reference as if set forth in their entirety. This application is also related to copending U.S. patent application Ser. No. ______, filed ______, and entitled “Method and System for Selectively Controlling the Utility a Target”, which is also incorporated herein by reference.

### BACKGROUND

1. Field

The present invention relates to a target that is enabled to have its utility selectively controlled, and the method and device for effecting a change of utility in the target. In a particular example, the invention uses radio frequency (RF) devices and processes to selectively control the utility of durable goods such as electronic devices or optical media.

2. Description of Related Art

Theft is a serious and growing problem in the distribution of products. In one example, electronic devices continue to shrink in size, while increasing their utility. As these electronic devices become smaller and more capable, they also become easier and more attractive to steal. Devices, such as digital cameras, DVD players, MP3 players, and game devices are popular targets of theft, not only in the retail store by consumers, but also by others in the distribution chain. For example, retail store employees, shippers, warehousers, and even employees of the manufacturer often steal products, and even boxes of products, for their own use or to sell. Other types of products are also subject to theft, such as DVDs, CDs, game discs, game cartridges, and other types of media. These types of products are also in high demand, and being relatively small and valuable, are easy and attractive to steal.

From the facility where they are manufactured to the retail point-of-sale (POS) where they are sold many high-value consumer products are vulnerable to theft. Various security techniques are used to minimize the losses (video cameras, security staff, electronic tagging, storing high-value items behind locked cabinets etc.). Despite these efforts theft of high-value targets such as DVD's, CD's and video games; portable video game players, DVD players, digital cameras, computers, printers, televisions and the like cost manufacturers and retailers billions of dollars per year.

Such rampant theft increase the cost of manufacturing, shipping, and selling of products. Each entity in the distribution chain is at risk for theft, and must take steps to reduce or control the level of theft. This cost is ultimately borne by the legitimate purchaser, which places an unfair “theft tax” on purchased products. Also, since may products are so easily stolen from a retail environment, retailers must take extraordinary steps to secure products. For example, DVDs, CDs, and small electronic devices are often packaged in oversized holders to make them more difficult to hide. These holders, however, also interfere with a consumers ability to interact with the product, ultimately making the product less attractive to the consumer. In another example, retail stores may place their most valuable and easily stolen products in locked cases. In this way, retail consumers are completely distanced from these products, which reduces theft, but also makes the products difficult to purchase. The consumer cannot read the full labeling on these locked-up products, can not physically interact with them, and must get the attention of a retail clerk, who might have a key, in order to get to the product. In another attempted solution, retail stores put security tags on products, which are intended to be disabled at the check stand upon purchase. If a consumer leaves the store with a live tag, then an alarm sounds. A guard or clerk is expected to stop the consumer and determine if the consumer has shoplifted a product. This process may be dangerous for the guard or clerk, and, since many of the alarms are false, causes undo stress for law-abiding consumers.

None of these attempts to stop retail theft has worked, and all make the retail experience less attractive to the consumer. In this way, the retailer is in the untenable position of having to accommodate and accept a certain (and sometimes significant) level of theft in order to maintain an attractive and desirable retail environment for paying customers. Further, neither the oversized holders, the locked cases, nor the guards address the significant level of theft that occurs between the manufacturer's dock to the retail shelf. Accordingly, the entire distribution chain has resigned itself to an “acceptable” level of theft, and passes the cost of theft on to the legitimate consumer.

The distribution of products faces other challenges. For example, consumers want to choose products that have a particular set of functions or utility, and find it desirable to purchase products matched to their specific needs. Accordingly, manufacturers often manufacture a product in several difference models, with each model having a different set of features. Although this is desirable from the consumer's standpoint, it complicates the manufacturing, shipping, inventorying, shelving, and retailing processes. This problem exists in the configuration of electronic products, computers, gaming systems, DVDs, CDs, game cartridges, for example. For a specific example, a DVD movie disc may be available in a family version, a theater version, and an “uncut” version. Each has a different age restriction, and will appeal to different and significant markets. Accordingly, three different versions must be manufacture, shipped, inventoried, shelved, and managed. A similar problem exists with feature sets for games, computers, and other products.

In another challenge for the distribution of products, it is sometimes desirable to rent a product to a customer for a set period of time. A typical example of a rental business model is the rental of optical media, such as DVDs. Rental models for content stored in physical media, i.e. movies recorded on video tape or optical disc, are typically dependent on the physical distribution of the media and in particular the checking-out and checking-in of the media out of, or into the retailer's inventory. In time-period based rental models, charges are related to how long the consumer has the media, e.g. the period between when the media is checked-out and when it is checked-in. In max-out subscription models, charges are based on the number of media checked-out to a customer less those that have been checked-in. In a max-turn model, charges are related to how frequently media are checked-out, or checked-in, by the retailer. These rental models suffer from several significant limitations. First the transport costs for each rental are substantial no matter how often the item is rented. Second they impose delays between the rental and selection decisions and the consumption of the item rented.

The video rental business illustrates the some of the limitations of these models. With traditional video rental stores, every time a customer rents a movie he must go to the store to pick-up the movie and then must go back to the store to return it. The time-period for which the consumer is charged depends on when the movie is checked-out and when it is returned and checked-in to inventory. In this model, the consumer bears the transport cost in the form of trips to and from the video store. The consumer also incurs delays between the rental and selection decisions and the actual watching of the movie. The video store incurs high costs too in the form of rent, inventory and the cost of checking-out and checking in each movie rented.

Even with alternative transport methods such as the US mail, there are always delays from the time when the movie is selected, when it is rented and when it is watched by the consumer. And if it is a max-out or max-turn model, there is a further delay until the movie is returned to the retailer, checked into inventory and another movie distributed to them. In both cases the retailer also incurs substantial recurring shipping and handling costs. Other transactions such as authorization, activation or authentication of tangible media such as tickets, coupons, vouchers, credit cards, product labels and tags, security devices, memory cards, removable computer storage devices (optical and electromagnetic), etc. share similar limitations.

Challenges also exist for non-commercial distribution of goods. For example, the military stores, transports, and maintains weapons and gear that is subject to theft and misuse. These weapons and gear must be available for rapid deployment and use, but yet must be sufficiently controlled so that they do not fall into enemy hands, or used in ways not approved by military command.

### SUMMARY

The present invention provides a distribution control system to support the controlled and selective changing of utility for a target. The target with controlled utility may be an electronic device, or alternatively, may be a tangible media, such as an optical disc. The distribution control system has a target with a change effecting device and a restricted access key. An activation device retrieves or generates an authorization key, and sends the authorization key to the target. The authorization key may be sent to the target wirelessly, for example, using a radio frequency signal. The target has logic that uses the restricted access key and the authorization key to change the utility of the target. In one example, the activation device retrieves the authorization key from a network operation center (NOC) by sending a target identifier to the NOC, and the NOC retrieves the authorization key for the identified target. The activation device may also connect to other systems for obtaining approval to change the utility of the target. For example, the authorization key may be sent to the target upon receiving payment, password, or other confirmation.

A target having a controlled utility is provided, as well as a method for changing the utility of the target. The target with controlled utility may be an electronic device, or alternatively, may be a tangible media, such as an optical disc. The controlled target has a change effecting device that is set to a first state, which allows the target to operate according to a first utility. The controlled target also has a receiver for receiving an authorization key, and logic which, responsive to the authorization key, selectively changes the change effecting device to a second state. When the change effecting device is in the second state, the target may operate according to a second utility. In one example, the controlled target has a restricted access key that was stored during manufacture, and the restricted access key is used by the logic in changing the state of the change effecting device. To change the utility of the controlled target, the controlled target is placed proximate to an activation device. The activation device may read an accessible identifier from the controlled target, and retrieve or generate an authorization key that is associated with the target. The activation device may cooperate with a network operation center or other entity to retrieve the authorization key, and to obtain approval to change the utility of the controlled target. If approved, the activation device may then send the authorization code to the controlled target.

In a specific example of the distribution control system, a target is manufactured with a change effecting device set to compromise the utility of the target. In this way, the compromised target would be nearly useless to a thief, and therefore would be less likely to be a target of theft. The manufacturer has also stored an identifier and a restricted access key with the target. The manufacturer also stores the accessible identifier and its associated key for later retrieval by a party authorized to restore the utility to the target. In one example, the identifiers and keys are stored at a network operation center (NOC). The compromised target may be moved and transferred through the distribution chain with a substantially reduced threat of theft. When a consumer decides to purchase the target, the target is passed proximally to an activation device. Its accessible ID is read by activation device, and using a network connection to the NOC, sends the accessible ID. The NOC retrieves the authorization key for the target. Additional approvals may be obtained, for example, confirmation of payment, identification, password, or age. When approved, the activation device transmits the authorization key to the target, typically using a wireless communication. The target receives the authorization key, and using its logic, compares the authorization key to its stored restricted access key. If the keys match, then the target uses an activation power source to switch the state of the change effecting device. Then, the target will have full utility available to consumer.

### BRIEF DESCRIPTION OF DRAWINGS

FIG. 1 is a block diagram of a network for distributing a target with controlled utility.

FIG. 2 is a block diagram of a network for distributing a target with controlled utility.

FIGS. 3A and 3B are block diagrams of target with controlled utility.

FIGS. 4A and 4B are block diagrams of a process for changing the utility state of a target with controlled utility.

FIG. 4C is a flowchart of a process for changing the utility state of a target with controlled utility

FIG. 5 is a block diagram of target with controlled utility.

FIG. 6A is a block diagram of an electronic device with controlled utility.

FIG. 6B is a block diagram of a processor with controlled utility.

FIGS. 7A and 7B are a block diagrams of an optical disc with controlled utility.

FIG. 8 is a flowchart of a process for changing the utility state of a target with controlled utility

FIG. 9A is a block diagram of a network for distributing a target with controlled utility.

FIG. 9B is a block diagram of a chain of distribution for a target with controlled utility.

FIG. 10 is an illustration of labeled targets with controlled utility.

FIG. 11 is an illustration of an electronic device with controlled utility having an external antenna member.

FIG. 12 is a diagram of an electronic device with controlled utility having an external antenna member.

FIG. 13 is a diagram of an electronic device with controlled utility having an external antenna member.

FIG. 14 is a block diagram of a target having controlled utility.

FIG. 15 is a block diagram of a target having controlled utility.

FIG. 16 is a circuit diagram of a target having controlled utility.

FIG. 17 is a circuit diagram of a target having controlled utility.

FIG. 18 is a circuit diagram of a target having controlled utility.

FIG. 19 is a circuit diagram of a target having controlled utility.

FIG. 20 is a circuit diagram of a target having controlled utility.

FIG. 21 is a circuit diagram of a target having controlled utility.

FIG. 22 is a block diagram of a target having controlled utility.

FIG. 23 is a block diagram of a target having controlled utility.

FIG. 24 is a block diagram of a target having controlled utility.

FIG. 25 is a block diagram of a target having controlled utility.

FIG. 26 is a block diagram of a server system for effecting a change in a target having controlled utility.

FIG. 27 is a block diagram of a server system for effecting a change in a target having controlled utility.

FIG. 28 is a diagram of using an activator to change the utility of a target having controlled utility.

FIG. 29 is a diagram of using an activator to change the utility of a target having controlled utility.

FIG. 30 is a diagram of using an activator and network to change the utility of a target having controlled utility.

FIG. 31 is a diagram of using an activator and network to change the utility of a target having controlled utility.

FIG. 32 is a diagram of using an activator and network to change the utility of a target having controlled utility.

FIG. 33 is a diagram of using an activator and network to change the utility of a target having controlled utility.

FIG. 34 is a diagram of using an activator and network to change the utility of a target having controlled utility.

FIG. 35 is a diagram of using an activator and network to change the utility of a target having controlled utility.

FIG. 36 is a diagram of using an activator and network to change the utility of a target having controlled utility.

FIG. 37 is a diagram of using an activator and network to change the utility of a target having controlled utility.

FIG. 38 is a diagram of using an activator and network to change the utility of a target having controlled utility.

FIG. 39 is a diagram of using an activator and network to change the utility of a target having controlled utility.

FIG. 40 is a block diagram of a target having controlled utility in a package.

FIG. 41 is a block diagram of a target having controlled utility in a package.

FIG. 42 is a block diagram of a target having controlled utility in a package.

### DETAILED DESCRIPTION

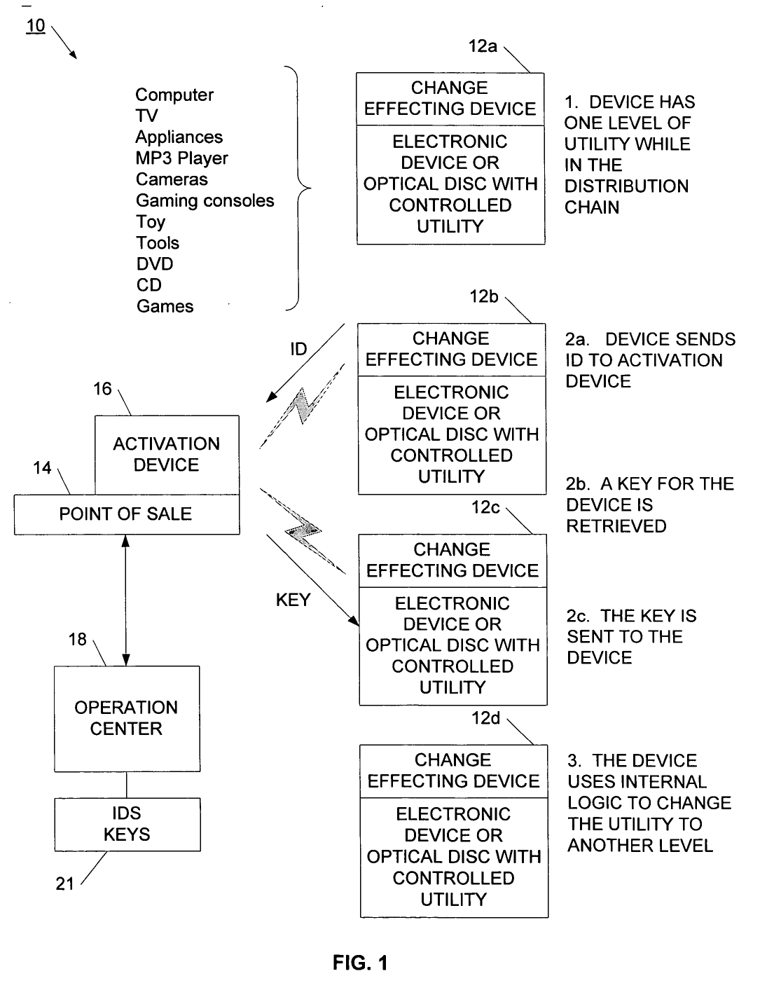

Referring now to FIG. 1, a system for controlling the utility of a target is illustrated. System 10 is illustrated with a target 12 at various points in a chain of distribution. Target 12 may be an electronic device such as a computer, TV, appliance, MP3 player, camera, game counsel, or toy. In another example, the target may be a tangible media, such as an optical disc, DVD, CD, or game cartridge. During manufacture or preparation of the target 12, the target has been associated with a change effecting device. The change effecting device is used to control the utility available for the target or for use of the target. More particularly, the change effecting device has multiple states, with each state being associated with an available state of utility for the target. In a specific application, the change effecting device may be switched between two available states of utility.

As shown at block 12a, when the target enters the distribution chain, the target is set to have one utility. For example, this utility could be a severely comprised utility, where the target has no useful function available. In another example, the set utility may be to a demonstration utility that allows limited demonstration functionality. It will be appreciated that the available utility may be set according the requirements of the specific distribution chain. At some point in the distribution chain, for example, when the target is transferred to a consumer, it may be desirable to change the available utility. Accordingly, block 12b shows the target in the presence of an activation device 16 at a point-of-sale or other transfer location 14. As the target is brought into proximity of activation device 16, the activation device or another reader is able to read an identifier value or other identification from the target. The activation device uses the identifier to generate or retrieve an authorization key. This authorization key may be stored locally at the point-of-sale device 14, or may be retrieved through a network connection to a network operations center or other remote server. The point-of-sale terminal 14 may have a connection to an operations center 18. The operation center may be in the same facility as the point-of-sale terminal 14, or may be in another facility at a different location. The operation center 18 may also have multiple computer servers, and may distribute processes and databases throughout the network system. The operation center 18 stores a set of associated identifications and authorization keys 21. In another example, the operation center 18 operates algorithmic processes to generate keys responsive to information received from activation device 16. Whether generated or retrieved, the operation center 18 sends an authorization key for the target to the point-of-sale terminal 14 where it may then be available to activation device 16.

A point-of-sale terminal at the point-of-sale 14, which typically is coupled to the activation device, may also perform various other tasks or processes as a precondition to determining that the target has been approved to have its utility changed. For example, the point-of-sale terminal may confirm payment for the target, or may confirm that the consumer is age-appropriate for the particular target being purchased. Provided the point-of-sale device has authorization to change the utility of the target, the activation device 16 transmits the authorization key to the target as shown in block 12c. In one example, the activation device 16 reads the ID from the target and transmits the authorization key to the target using an RF (radio frequency) communication. It will be appreciated that other types of wireless communication may be used. For example, the communication may use infrared (IR) communication in one or both directions. In another example, the target may make physical contact with the activation device for effecting the communications.

As shown in block 12d, the target then uses the received authorization key to switch the change effecting device to another state. In this other state, the target has a different utility than when the change effecting device was in the first state. The target has logic coupled to the change effecting device that uses the authorization key to effect a change in the target's utility. In one example, the target has a restricted access key that was defined and stored with the target during the manufacturing process. This restricted access key may not be externally read, altered, or destroyed, but may be read or otherwise used by the target's logic. This restricted access key may be compared or otherwise used with the received authorization key to determine if the target is enabled to change states.

In a specific example of system 10, target 12 is illustrated to be an MP3 player. During manufacture of the MP3 target device, a restricted access key is stored in the MP3 player. Also, a change effecting device is installed in the MP3 player, and set to a state so that the MP3 player's utility is compromised. More specifically, the change effecting device has a first state in which the MP3 player does not power on or otherwise properly function, and a second state where the MP3 player is allowed to be fully operational. The change effect device may be, for example, a printed circuit board trace coupled to ground. This grounded trace may then be coupled to a pin on a processor of the MP3 player, and as long as that pin is held to ground, the MP3 player will not power on or initialize. It will be appreciated that the utility of the MP3 player may be compromised in several alternative ways and by several alternative change effecting structures. The MP3 player is also manufactured with a power source associated with the change effecting device for selectively decoupling the trace to ground. This power source may be a battery, an electromagnetic or RF converter, or may be power obtained from the MP3 player's operational battery.

The MP3 player is thereby manufactured and ready for sale as a compromised MP3 player that will not properly power on or function. In this way, the compromised MP3 player would be nearly useless to a consumer, and therefore would be less likely to be a target of theft. The manufacturer has also applied an accessible identification to the MP3 player. For example, the accessible identifier may be a bar code, or may be another stored value that is accessible through, for example, an RFID reader system. The manufacturer stores the accessible identifier and its associated key value for later retrieval by a retailer or other party authorized to restore the utility to the MP3 player. The compromised MP3 player may be shipped through the distribution chain and to the retailer with a substantially reduced threat of theft. Also, the retailer may display and make the MP3 player available for customer handling in a retail environment with reduce risk of theft. In this way, reduced security measures may be taken at the retail level, such as using locked cases or sophisticated packaging, since the consumer would obtain no benefit by stealing a nonworking, compromised MP3 player.

When a consumer decides to purchase the MP3 player, the consumer may take the MP3 player to the point-of-sale terminal 14 and have it passed proximally to an activation device 16. As the MP3 player is close to the activation device, its accessible ID is read by activation device 16, either using the bar code value or by retrieving the stored accessible ID using a wireless or EM (electromagnetic) communication. For example, the communication may be an RF (radio frequency) communication. The point-of-sale terminal may have a network connection to an operation center 18, and sends the accessible ID to the operation center. The operation center, which has a database of MP3 player identifications associated with their restricted access keys, retrieves the particular authorization key for the MP3 player that is at the point-of-sale device. At the point-of-sale terminal 14, additional confirmation actions may be taking place. For example, a clerk may be accepting payment from the consumer, or may be checking a consumer's identification or age. These other confirmation criteria may then be used to confirm that the point-of-sale terminal is ready to restore the utility of the MP3 player. Provided the activation device 16 determines restoration is appropriate, the activation device 16 transmits the authorization key to the MP3 player, typically using a wireless communication. The MP3 player receives the authorization key, and using its logic, compares the authorization key to its pre-stored restricted access key. If the keys match, then the MP3 player uses its activation power source to open the trace to ground. With the ground trace now open, when the MP3 player is next turned on, full utility will be available to consumer.

In another example, the consumer purchases the MP3 player from an online retailer, and the MP3 player is shipped or mailed to the consumer. In this scenario, several alternatives exist as to where the utility for the MP3 player may be restored. In one alternative, the online retailer has an activation device in their warehouse or shipping department, and a retail employee restores the utility to the MP3 player as part of the shipping process. In another alternative, the MP3 player is shipped with compromised utility, and the shipper has an activation device that they use to restore utility prior or at the time of delivery. In this alternative, the driver of the delivery truck may restore utility as the consumer accepts the MP3 player, thereby removing risk of theft during the entire shipping process. In a final alternative, the consumer has a home activation device, and the consumer uses the activation device to restore utility to the MP3 player. In this last alternative, the MP3 player is in a compromised utility from the manufacturer all the way to the consumer's location, and it is the consumer, after the commercial transaction is complete, that finally restores utility to the MP3 player.

In some cases, the MP3 player may have additional circuitry for confirming that the utility has been restored. For example, the state of the change affecting device may be measured, or another test or measurement may be taken. According to whether or not activation was successful, a different value may be placed in a confirmation memory. The confirmation memory may be read by the activation device 16 to confirm to the consumer and to the network operations center that activation was successful. By confirming successful activation, the retailer may have a higher degree of confidence of consumer satisfaction, and may accurately and timely report and authorize payment to the supplier of the MP3 player.

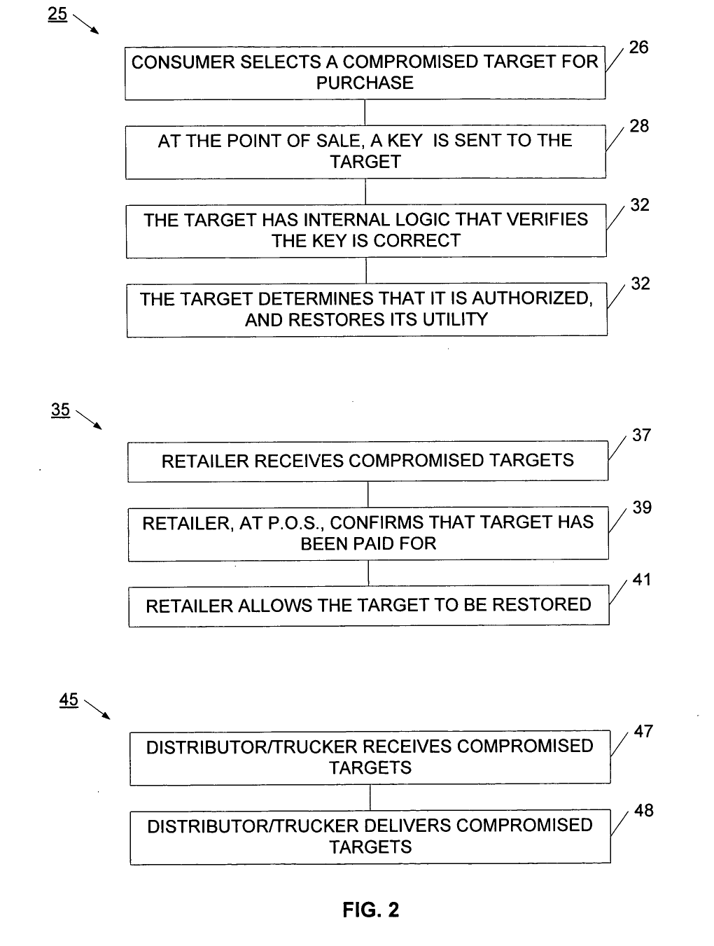

Referring now to FIG. 2, a process for using a compromised target is illustrated. Method 25 shows that a consumer selects a compromised target for purchase as shown in block 26. This purchase may be, for example at a bricks-and-mortar retail location, or at home where the target was ordered from an online ordering system or a mail-order catalog. At the time the consumer makes the selection to make the purchase, the target has no or limited utility, and therefore would be of little value to a potential thief. In this way, risk of theft is substantially reduced as there is little benefit that a thief could easily derive from a stolen target. However, at some point in selling the target, the utility needs to be restored to the item. Accordingly, at a time, place or responsive to an event as a set by the retailer, an authorization key is sent to the target as shown in block 28. This may be done, for example, at a point-of-sale terminal at a retail outlet, using a remote activation device located at a consumer's residence, or at another place as selected by the retailer. The target has its own internal logic, change effecting device, and activation power supply so that it is able to confirm that the authorization code is correct, and switch its change effecting device to restore utility as shown in block 32. Once the target has determined that it is authorized, and the change effecting device has been switched to its restored state, the full utility has been restored to the target. In another example, the level of restored utility is dependent on the particular value of the authorization code. In this way, the target may have multiple authorization keys, with each key capable of setting a different level of utility to the target. Then, responsive to the particular authorization key received, the target restores a predefined level of utility. Advantageously, method 25 allows the retailer to minimize theft, while maintaining a high consumer satisfaction level.

Method 35 shows that a retailer receives compromised targets as shown in block 37. These target items may be, for example, electronic devices that do not function according to specifications, electronic items that do not properly power up, electronic devices that have severely limited or only demonstration capabilities, or optical media, DVDs, or CDs that cannot be read in their respective players. In this way, these compromised targets are of little to no value to any potential thief, so risk of theft has been substantially reduced. At a time, place, or responsive to an event determined by the retailer, the retailer may authorize full utility to be restored to the item as shown in block 39. Responsive to this confirmation, the target is restored as shown in block 41. In this way, the retailer controls the particular time, place, or event that is sufficient to restore utility to the device. In moving the compromised target through the distribution chain, it is typical that the target may be transferred using shipping, trucking, or other transportation services. Method 45 shows that a distributor or trucking company receives targets in a compromised configuration. In this compromised configuration, they would not be operable by any thief, so therefore would be subjected to a much lower risk of theft. The distributor then transports the targets to their intended location, and delivers the compromised items as shown in block 48. Advantageously, from the time the distributor or trucker received the items in block 47 to the time the distributor or trucker passes the items to the next party in block 48, the targets are under a substantially reduced risk of theft.

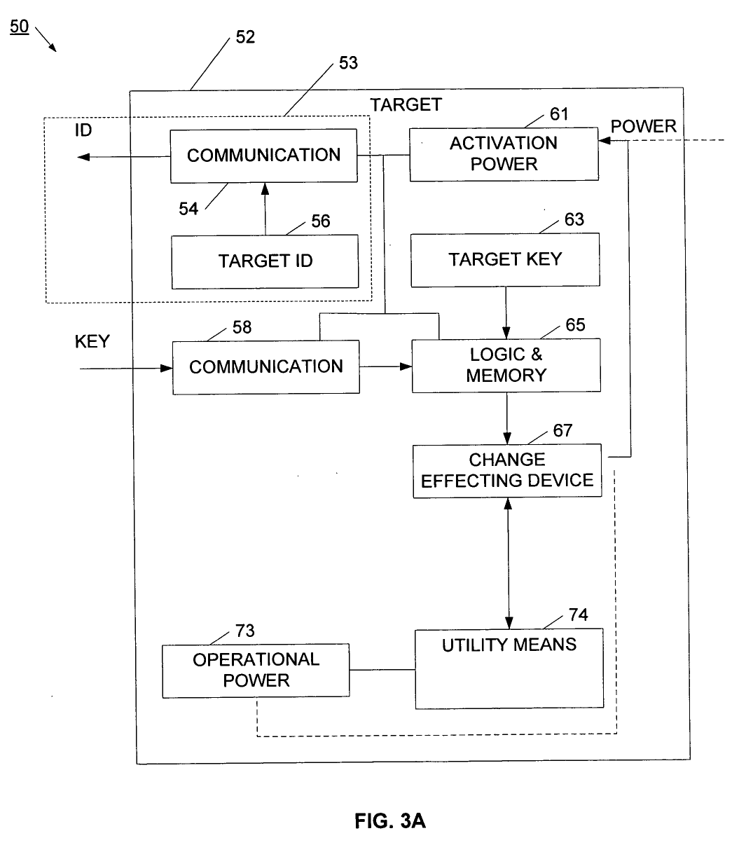

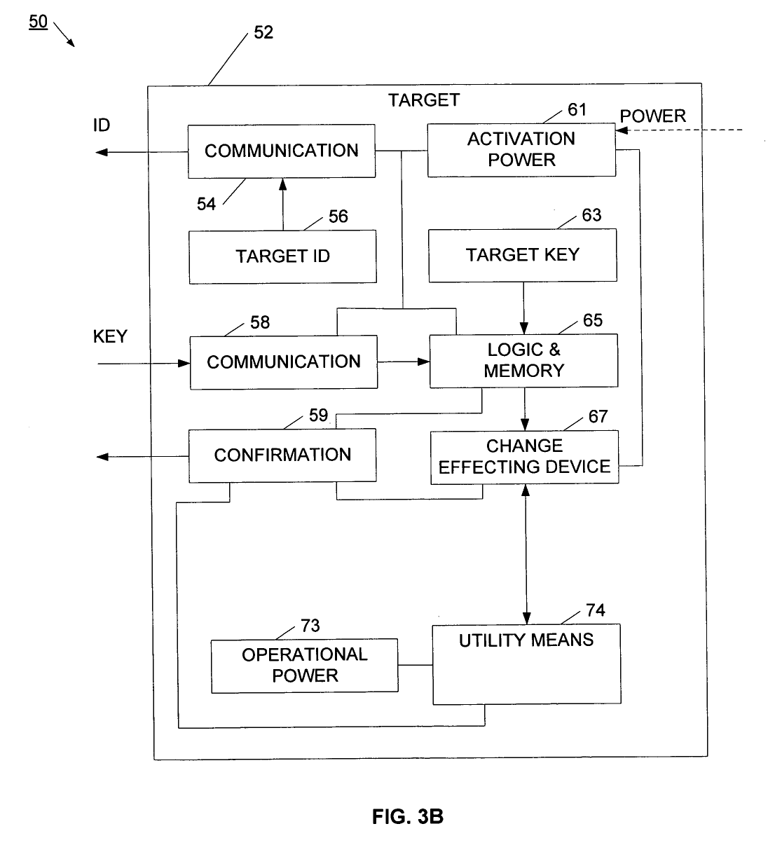

Referring now to FIG. 3A, a target for a controlled distribution system is illustrated. Target 50 typically has a housing 52 and may be enclosed in packaging. In one example, target 50 is an electronic device, and in another example, target 50 may be a tangible media such as an optical disc, DVD, game cartridge, or CD. Target 50 is typically manufactured and enters a distribution chain until it is received by a retailer. A retailer typically displays and sells target 50 to a consumer. The consumer purchases target 50 to obtain a particular useful utility. For example, if target 50 is an MP3 player, then the consumer expects to be able to play MP3 music files to a speaker or headset system. In another example, if the target is an optical disc containing a movie (DVD), then the consumer expects to be able to insert the DVD into its respective player, and watch and listen to a high quality movie. However, target 50 is constructed to have multiple states of utility. In this way, a target may be provided in the distribution chain at one state of utility, and then, when transferred to a consumer, may be placed in a second state of utility. In a more specific example, target 50 may be compromised to have its utility nearly fully disabled while in the distribution and retail environments. Then, upon transfer to a consumer, the target is switched to have full utility. In this way, the risk of theft in the distribution and retail areas is substantially reduced as there is no benefit available for stealing the target. Accordingly, target 50 is intended to cooperate with an activating device, which may be in communication with the network operations center, and as part of an overall distribution control system. Processes and methods for activating optical media is more fully set out in U.S. patent application Ser. No. 10/874,642, filed Jun. 23, 2004, entitled “Method and Apparatus for Activating Optical Media”; and U.S. patent application Ser. No. 10/632,047, filed Jul. 31, 2003, entitled “Wireless Activation System and Method”, both of which are incorporated herein by reference.

Target 50 is constructed to receive an authorization key via a communication circuit 58. Communication circuit 58 may be a wireless communication circuit, such as a radio frequency or electromagnetic receiver. The target has logic 65 which is configured to receive the authorization code and make a determination if the target should have its utility changed, how its utility should be changed, or what change should be made to its utility. The logic may include logic structures as well as dynamic or non-volatile memory. In one example, logic 65 uses a target key 63 in making the determination of whether or not the target can change to another level utility. In one example, target key 63 has been stored during the manufacturing process in a manner that is not readable using external devices. For example, target key 63 may be placed in a nonvolatile, non erasable and non alterable memory during manufacture. This target key may be the same value as the authorization key, so the logic simply performs a comparison between the restricted access target key 63 and the received authorization key to determine if the utility of the target may be changed. It will be understood that other logical processes may be used in making this determination. Provided the logic 65 determines utility may be changed, the logic causes a change effective device 67 to change states. The change effecting device may be, for example, an electronic switch, an electrical switch, a fuse, a conditional break in a trace, a logical state, or may be a set of values defined in a memory location. In another example, the change effecting device is an electrically switchable optical material such as electrochromic material. It will be appreciated that other devices may be used for change effecting device.

The change effecting device may change state upon the application of an activation power 61, or may use logical process to set or change values stored in memory. The activation power 61 may be, for example, a separate battery which powers the logic 65, the communication process 58, and the change effecting device 67. In another example, the activation power 61 may be a converter for converting a received radio frequency or electromagnetic energy into available power. Also, the activation power may be wholly or partially obtained from a source external to the target. It will be appreciated that other electronic components may be necessary to implement such a converter. In another example, activation power may be provided by the operational power 73 for the full device. It will be appreciated that not all targets will require an operational power source. For example, if the full device is an MP3 player, and the MP3 player has an operational rechargeable battery, the rechargeable battery may have sufficient initial charge to power the activation circuitry while the target is in the distribution chain. In yet another example, activation power 61 may be provided by multiple power sources. For example, a small battery may power the change effecting device, while an RF or EM converter device may power the logic and communication 58. It will be appreciated that many options and alternatives exist for powering the circuitry within target 50.

In one example, target 50 is an electronic device that has an operational power source 73 for powering the utility of the device. The utility device is directly affected by the utility means 74. For example, the utility means may be a power supply, processor, motor, display, executable code, a memory, an amplifier, a print head, or lamps. It will be appreciated that very many types of utility circuits and utility means may be used. Target 50 has an operating state where the operational power is applied to the utility means 74. However, the utility means 74 couple to the change effecting device 67 to determine what level of utility may be available. For example, in one state, the utility means may not allow a power supply or motor to operate, thereby effectively disabling target 50 from any meaningful operation. In another example, the change effecting device may cause utility means to operate target 50 in a reduced utility or demonstration mode. This will allow a device to operate with limited capability at a retail store, and then at a later time upon restoring full utility, a consumer may enjoy the full benefit of the target. It will be appreciated that Target 50 may include one or more isolation circuits to isolate the operational power 73 from the change effecting device 67 and its associated logic and communication circuits. The isolation would protect the change effecting device and logic from damage when operational power is applied, and conversely protect the utility means from damage when power is applied to the change effecting device to cause it to change states. It will be appreciated that many isolation processes and circuits may be used.

In a more sophisticated distribution model, target 50 has an accessible target ID 56. Target ID 56 may be, for example, a barcode value or an RFID value. Upon request from an activating device, the target 50 communicates its target ID using a communication circuit 54. Communication circuit 54 may be as simple as an RFID communication circuit for transferring an RFID value to the activating terminal. Then, the activating terminal may retrieve or generate an authorization key according to the target ID. This key is then communicated to communication device 58, so that logic 65 may compare it to the stored restricted access target key. Using the target ID, a particular individual target, or a class of targets, may be particularly associated with an authorization key. It will be appreciated that FIG. 3A shows functional block relationships, and that a corresponding circuit implementation may further separate some functions, and combine other functions. For example, an operational target circuit may use a single RF transceiver device to function as the receive communication function 58 and the send communication function 54.

Referring now to FIG. 3B, target 50 is illustrated with an alternative construction. In this configuration, target 50 is constructed to provide a confirmation that its utility has been effectively controlled. In this regard, target 50 has a confirmation circuit or memory 59 which changes state according to the actual or probable state of utility for target 50. In some cases, the actual state of the utility may be detected, or the actual state of the change effecting device may be measured or detected. In other cases, the actual states may not be conveniently measured or detected, so some aspect of the change process may be measured or detected instead. In this case, a confirmation that change process was being successfully performed leads to a high probability that the utility of the target was also successfully changed. Accordingly, the confirmation circuit 59 may directly measure the state of the change effecting device 67, or may have measured the electrical processes used in making the change. For example, confirmation circuit 59 may measure the current passing through a fuse, and thereby confirm that a sufficient amount of electricity has passed through the fuse to cause it to break. Although not a direct detection of the state, it is highly probable that the state of the fuse has changed, resulting in a change of state in the utility for the target. In another example, confirmation circuit 59 may couple to logic 65, and may confirm that logical processes were properly performed for doing the activation. In another example, confirmation circuit 59 may directly connect to the utility means or the utility device itself, to confirm that activation occurred. Once confirmation circuit 59 receives confirmation that the means required to effect the desired change in the utility of the target have changed, that confirmation signal may be communicated to an activator device using a transmitter, or may be read responsive to a request from the activator. The target as illustrated in FIG. 3B therefore provides feedback to the activation and distribution control system to confirm that utility has been changed. This information may then be used to generate reports or two initiate payment to parties within the distribution chain.

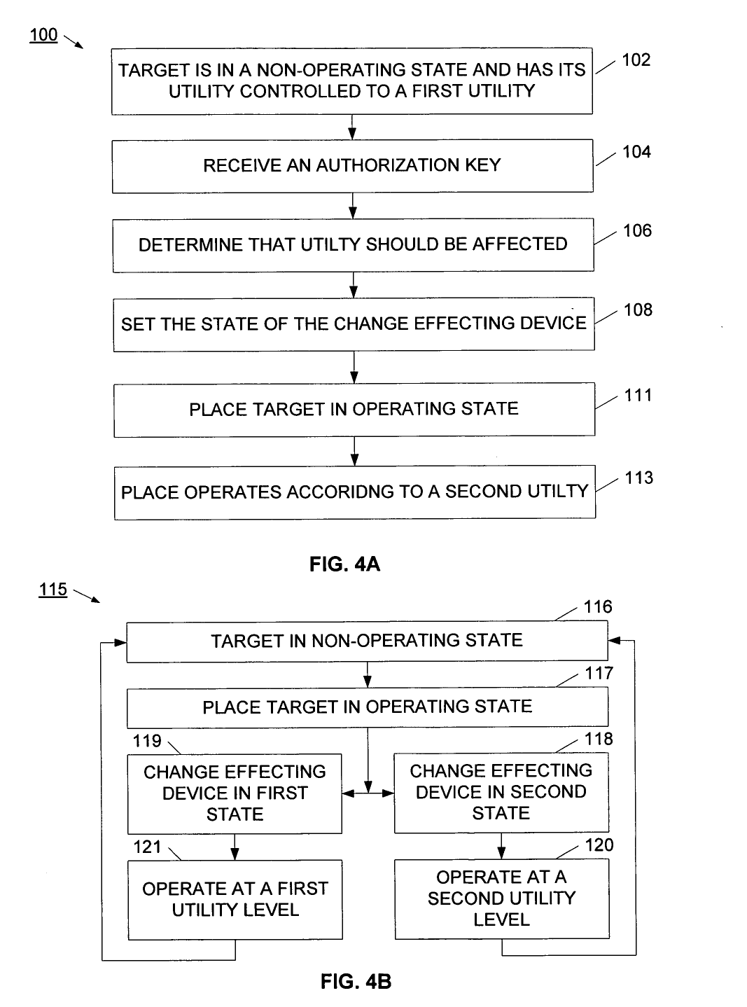

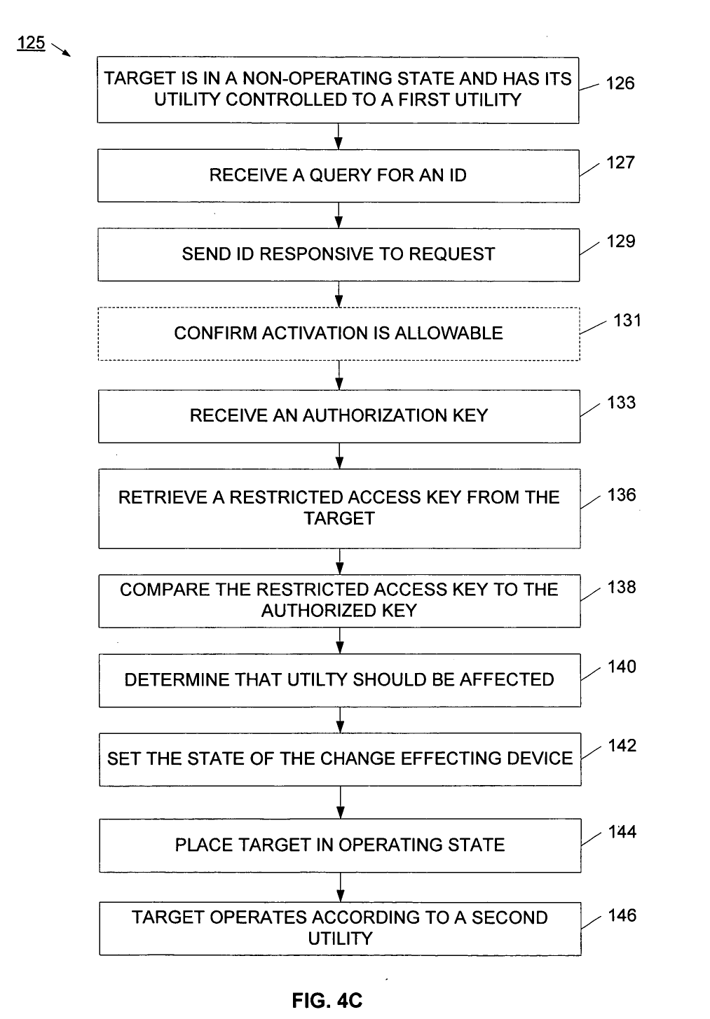

Referring now to FIG. 4A, a method of controlling the distribution of an electronic device is illustrated. In method 100, a target is provided in a non-operating state, for example, with its main power in an off condition. The target also has been manufactured with a controlled utility, which causes the target to operate only in a first level of utility as shown in block 102. For example, the first utility may be a highly compromised utility level where the target has no practical useful value to a consumer. In this way, a consumer, or someone in the distribution chain, will be unlikely to shoplift or steal the device. At a time selected by the retailer or another authorized person in the distribution chain, the target receives an authorization key as shown in block 104. Typically, this key will be received at a retail point-of-sale through a wireless communication, although other locations and processes may be used. The electrical device uses its logic and activation power to determine if it is authorized to change from the first utility level as shown in block 106. Provided the proper authorization key was received, the electrical device uses its activation power and logic to change the state of a change effecting device from a first state to a second state as shown in block 108. At a later time, for example, when the consumer takes the electrical device home, the consumer may plug in or power-on the electronic device as shown in block 111. Since the change effecting device is now in its second state, the target operates according to the second-level of available utility as shown in block 113. For example, the second utility may be a full operational utility.

In another example, the first utility may be a demonstration utility, and the second utility may be full operational utility. In yet another example, the first utility may be a full operational utility, and the second utility may be restricted utility for an age restricted product. In this way, a retailer may disable certain features or functions in an electronic device according to the age of the consumer. In another example, a consumer may purchase a device according to a list of desired features. The full operational device may be placed with the activating device, and undesired features compromised. In this way, a flexible configuration of electronic devices may be accomplished at a point-of-sale or service area in a retail environment. Although the electronic device has been described as having its utility change upon transfer to a consumer, it will be appreciated that utility may be changed at other times. For example, a manufacturer may use the change effecting device to particularly configure an electronic device prior to shipment. In this way, a standard version of an electronic device may be made, and the utility selectively added or removed using one or more change effecting devices. It will also be understood that this dynamic configuring process may be performed at other times, for example, by service personnel at the retail outlet. In a similar manner, a manufacturer may prepare an optical media, such as an optical disk, with multiple change effecting devices, with each change effecting device arranged to affect a particular utility of the media. Then, at some point in the manufacturing or distribution process, the utility of the media may be changed. In this way, a standard version of a media, and media content, may be made, and the utility selectively added or removed using one or more change effecting devices. It will also be understood that this dynamic configuring process may be performed at other times, for example, by service personnel at the retail outlet.

Referring now to 4B, a process of using an electronic device target is illustrated. Method 115 has an electronic device in its non-operating state as shown in block 116. This state may be for example, when the electronic device is not plugged in or when its power button is in an off configuration. The electronic device may be placed in its operating state as shown in block 117. For example, the electronic device may be plugged in or have its power switch turned to on. Then, depending upon the state of the change effecting device, the level of utility available in the electronic device would be different. For example, if the change effecting device is in a first state as shown in block 119, then the electronic device is allowed to operate at a first level of utility as shown in block 121. However, if the change effecting device is in a second state as shown in block 118, then the electronic device operates at a second-level of utility as shown in block 120. As illustrated in method 115, the electronic device has a level of utility which is always dependent on the state of the change effecting device. Accordingly, the change effecting device may cause an electronic device to be always unusable unless it has received the proper authorization key. If the authorization key is never received, the electronic device remains at its first state of utility. In a specific example, if the first level of utility is a highly compromised level, then the electronic device would have no practical usability by a consumer in its first state. In this way, risk of theft is dramatically reduced as no benefit can be derived from the electronic device if stolen and it is in its first state.

Referring now to FIG. 4C, a specific method for controlling the distribution of an electronic device target is illustrated. Method 125 has an electronic device target that has an operating state and a non-operating state. Typically, the non operating state will be a power off condition, while the operating state will be a normal power on condition. The electronic device has also been manufactured to have its utility controlled and initially set to a first level of utility as shown in block 126. The electronic device moves through the distribution chain until it reaches a point where one of the parties in the distribution chain determines it is appropriate to change the utility of the electronic device. For example, this may be at a point-of-sale when a retailer transfers the electronic device to a consumer, or may be done by a distributor to add or delete particular utilitarian functions. Since the utility of the electronic device has been initially set to the first level of utility, if the electronic device is placed into its operating state, its utility will only be available as the first level of utility. For example, if the electronic device has had its utility fully compromised, then the electronic device may fail to power on, or will have its utility disabled to a point of being functionally useless.

When the electronic device is in its non operating state, and it is desired to change to a second state of utility, the electronic device is moved proximate to an activating device. This activating device may be, in one example, an activating terminal at a point-of-sale stand, or may be a device at another location. The electronic device receives a query for an accessible ID as shown in block 127. This accessible ID may be stored as a memory value to be read wirelessly, or may be a barcode value to be scanned. The ID is sent back to the activating device as shown in block 129. The activation terminal may cooperate with other local or remote systems to approve changing the target's utility as shown in block 131. For example, the activation terminal may confirm credit card payment, confirm password, confirm membership in an organization, confirm the activation terminal is authorized, or confirm the age of the consumer. Provided the target is approved to have its utility changed, the activation terminal sends an authorization key that is received by the target as shown in block 133. Typically, the authorization key will be received wirelessly, for example, using an electromagnetic process such as a radio frequency communication. The target, which is still in its non operating state, retrieves a restricted access key stored with the target. This restricted access key is not available to be read by an external device, and is in a non-alterable and nonvolatile memory. The restricted access key typically has been stored with the target at the time of manufacturing, and a copy of the authorization key, along with the associate ID was stored for retrieval by the activation device. Accordingly, the logic within the target may retrieve or otherwise use the restricted access key and compare the restricted access key to the authorization key as shown in blocks 136 and 138. If the keys are the same, then the target has determined that the utility of the target should be changed as shown in block 140. The logic then cooperates with a change effecting device to change the state of the change effecting device to a second state as shown in block 142. This change effecting device is coupled to a utility means, which is used to direct the particular utility available to the electronic device. Accordingly, when the electronic device is placed in the operating state as shown in block 144, the electronic device operates according to its second utility as shown in block 146.

Referring now to FIG. 5, another target for a distribution control system is illustrated. Target 150 is similar to target 50 described with reference to FIG. 3A and therefore will not be discussed in detail. As with target 50, target 150 has a communication circuit 158 for receiving an authorization code from an external activation device. The communication module 158 cooperates with logic 165 and a change effecting device 163 to switch the state of the change effecting device between a first state and a second state. Responsive to this change in state, utility means 171 provide a different level of utility for target 150. The target may have an activation power source 159 for powering the communication, logic, and change effecting device, while an operational power source 173 powers the main operating circuitry and devices within the target. Target 150 may also have a restricted access target key 161, and an accessible target ID 156. Communication circuit 154 may be used to send the target ID value 156 to an activation device. Target 150 has the primary components of the target stored in a housing 152. In one example, housing 152 is a case or other enclosure. Since housing 152 or other aspects of the target may restrict wireless communication to components within the housing 152, certain circuits and processes for target 150 are placed external 151 to the main target housing 152. In the example illustrated in FIG. 5, the external portion 151 has the activation power, (which may be in the form of a battery or RF/EM converter), communication circuitry 158, communication circuitry 154, and the accessible ID 156. In a typical construction, however, the external portions will be limited to the antenna and antenna support circuitry, along with any RF power converter circuit, and the target ID is stored within the target housing 152. In this way, the circuitry needing clear access to wireless communications is positioned external to the target. Other circuitry for changing utility of the target may be stored within the target housing 152. It will be appreciated that other circuitry may be moved from within the housing to the external portion 151. For example, the target key and logic may be moved externally in some cases. Also, if activation power 159 includes a battery, that battery may be positioned either within the housing 152 or on the external portion 151.

The external portion 151 may be mounted or adhered to the target housing 152, or may be positioned remote from the target and coupled to the target housing 152 through a wired connection. In another example, the external portion 151 may couple to the target housing 152 through a connector 166 available on the target housing 152. In one example, the target housing 152 may have power input ports, on which the external portion may temporarily mount. In such a case, the target 150 would be activated with the external portion 152 coupled to the power plug of the housing 152, and after processing at the activation terminal, the external portion 151 would be removed from the power plug, and the power plug inserted into a wall outlet to place the electronic device in its operable state. It will be appreciated that other available connectors may be used. For example, an existing audio, video, or data connector may be used. However, when using an standard connector 166, it may be desirable to provide an isolation circuit 167 to protect target circuits 169 from detrimental effects of the external portion 151. The isolation circuit 166 is also used to direct the received authorization key to be communicated to the logic 165 when the utility of the target is to be changed, and, when the target is in an operational mode, to direct signals at the connector to be routed to their regular target circuits 169. For example, if connector 166 is an audio connector, then, when the target is operational, signals at the connector 166 would be routed to the audio target circuits 169. It will be appreciated that the design and construction isolation circuits is well known, and will not be discussed in detail. By constructing parts of the activation circuitry external to the target, more robust communication with the activation device may be maintained, as well as more efficient and effective power conversion when converting power from an available R F or EM source.

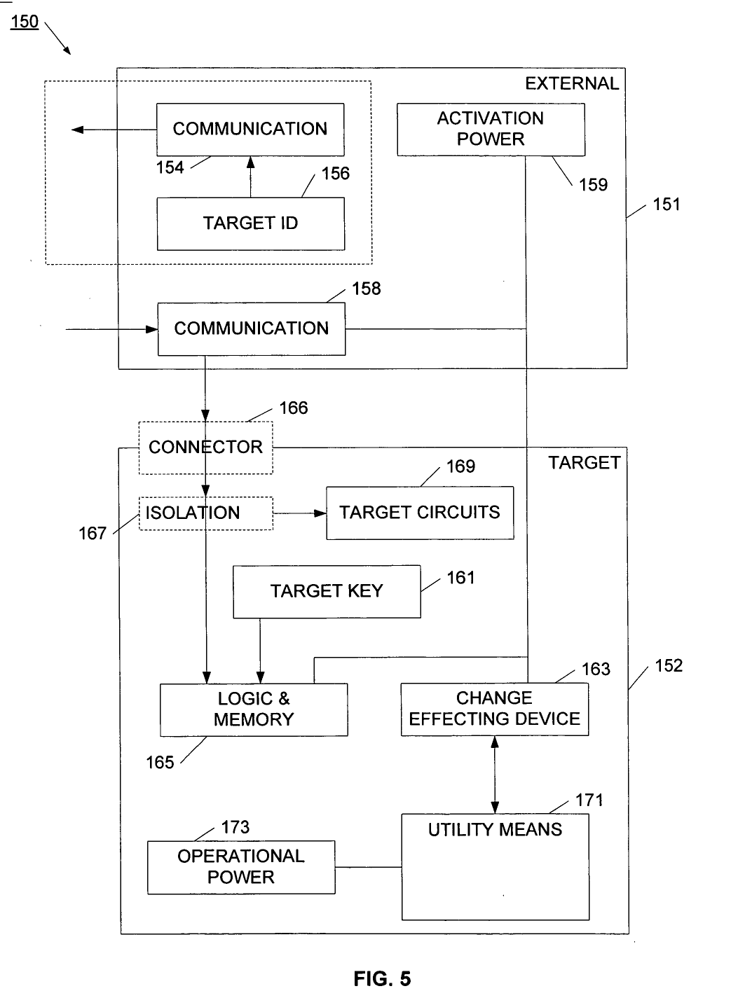

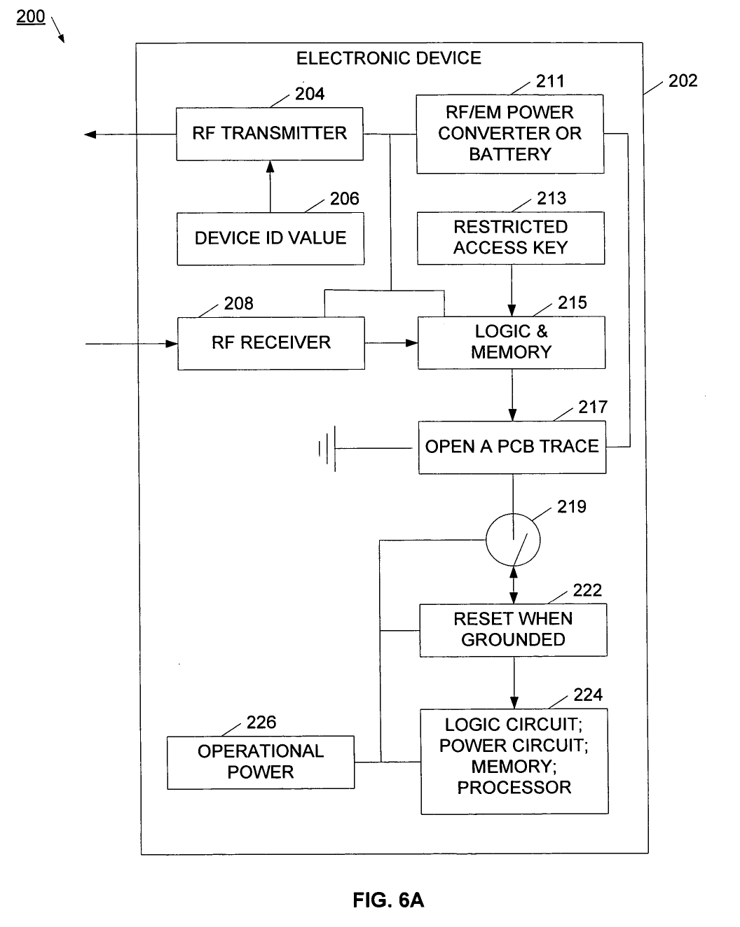

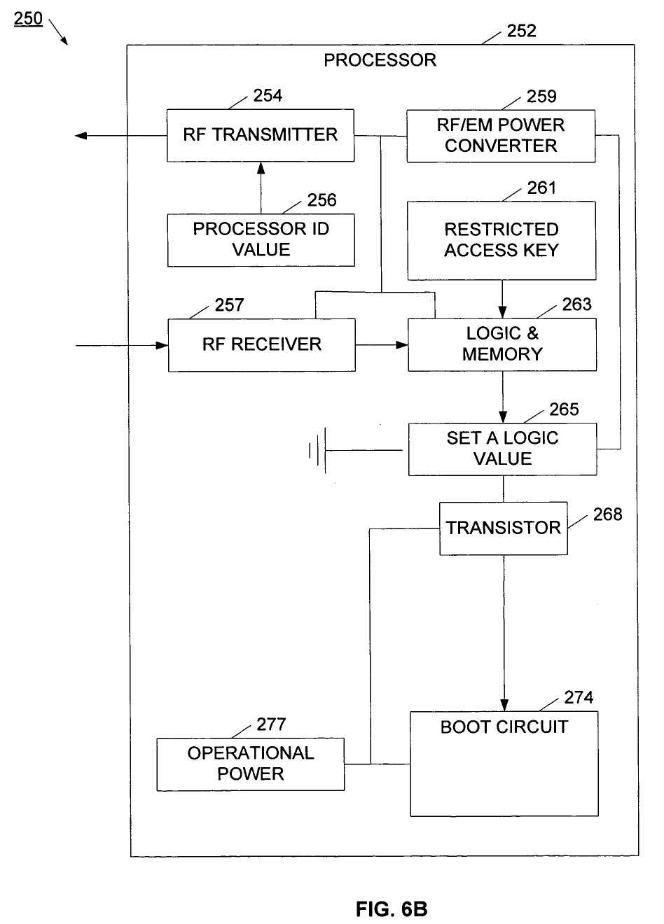

Referring now to FIG. 6A, an electronic device target 200 is illustrated. Electronic device 202 has been manufactured with its principle utility compromised. In this way, as electronic device 202 moves through the distribution chain, it has little or no perceived value to a potential thief or shoplifter. Accordingly, the risk of theft is substantially reduced. The electronic device 202 is constructed to have its utility means enabled through a logic circuit, power circuit, a value stored in memory, or processor operation as shown in block 224. The particular utility means being used has no utility when an electronic connection is grounded as shown in block 222. When operational power 226 is applied, for example when the target's power-on switch is activated, switch 219 closes, which pulls a reset pin to ground when the printed circuit board trace 217 is shorted to ground. In this way, even though operational power has been applied to the utility means 224, the electronic device has its processor or logic circuit constantly in a state of reset, so that the electronic device has no useful utility. Accordingly, any time the electronic device 202 is turned on when the change effecting device 217 is in its first state, the key functionality or utility of electronic device is compromised.

When a consumer purchases the electronic device at a retail outlet, the electronic device 202 is brought into proximity with an activating device. The activation device makes a request for an ID value, and then an RF transmitter 204 takes an ID value 206 and transmits it to the activation device. It will be appreciated although RF communication is illustrated, other types of wireless communication may be used. The activation device may then cooperate with remote servers, network operating centers, clerks, and the consumer to determine that the target 202 is approved to have its utility restored. Provided the activation terminal has been properly authorized and the interested parties have determined that the electronic device may be restored, then the activation device sends an authorization key, which is received by RF receiver 208. The RF receiver 208 passes the received authorization code to logic 215, where the authorization code is compared to a restricted access key 213. The restricted access key 213 was stored in the electronic device during the manufacturing process. Provided the restored restricted access key 213 and the authorization key match, the logic causes the PCB trace to be opened. A power source 211 is used to power the transmitter 204, the receiver 208, logic 215, and the change effecting device 217 when the electronic device is not in its operational condition. This power source may be, for example, a battery, an RF/EM power converter or may even be a connection to the operational power source 226. In one example, the RF receiver 208 acts as a receiver for RF/EM power converter 211. It will also be appreciated that different types of power sources may be concurrently used.

Once the PCB trace 217 has been opened, then each time operational power is applied 226, the switch 219 will close. In this way, the voltage on the reset pin will be allowed to float and not pulled to ground. Accordingly, the logic circuit will not be reset. The electronic device may then proceed normally with its power up or initialization routine and function with full utility. It will also be appreciated that multiple authorization keys or multiple change effecting devices may be used. In this way, several utility states may be selectively enabled.

Referring now to FIG. 6B, a computer processor target 250 is illustrated. Processor 252 may be, for example, a microprocessor, a gate array device, a DSP, or other processor circuit. Although a processor is illustrated, it will be appreciated that other logical and memory devices may be used. Processor 252 has been manufactured with a restricted access key 261. The restricted access key has also been stored in a database and associated with the processor ID value 256. Processor 252 has a change effecting device in the form of a logic value 265. The logic value may not be read externally, and is stored in a nonvolatile and nondestructable way. The logic value is set such that when the logic value is set to a first state, the boot circuit 274 of the processor causes a boot failure. In another example, the initially set value may cause the processor to only boot into a restricted mode, so that simple operations may be performed, but full utility is not available. Typically, operational power 277 will be a pin or trace receiving power from an external source. The activation circuits are protected from the operational power, and the operational circuits are protected from the activation circuits through an isolation transistor 268. For example, an operational transistor 268 may be properly biased and coupled to the operational power 277, so that the logic value may be read by boot circuit 274 when operational power is applied. In this way, each time processor 252 is powered up, it checks to see what level of utility it should provide.

The processor 252 may be sold as a discrete component, or may be installed as a component in a larger device, such as a computer system, camera, or MP3 player. In some cases, it may be useful to have the wireless communication and power circuits external to the processor device itself. When the processor or integrated device holding the processor are desired to be activated, the processor uses its RF transmitter 254 to transmit a processor ID 256 to an activation device. The activation device generates or, retrieves an authorization key, which may be the same value as the restricted access key 261. The authorization key is received by RF receiver 257, which cooperates with logic 263 to set a new logic value into logic value area 265. A power source, such as an RF/EM power converter 259 is provided to power the activation circuitry and to assist in setting the new logic value. Once the processor has a new value set in logic value area 265, then each time the processor is powered on, the processor will perform at a utility level set by the new logic level. Typically, the new logic level will enable full use of the processor. It will be appreciated that various levels of utility may be set in this arrangement. It will also be appreciated that utility may be added or deleted from the processor according to the received authorization code. In this way, multiple restricted access codes 261 may be stored, with each being associated with a different level of processor utility. Although processor 252 has been illustrated with the RF transmitter 254, the RF receiver 257, and the power source 259 integrally arranged in the processor, it will be appreciated that all or some of these structures may be provided external to the processor housing. For example, the transmitter 254, receiver 257, and power source 259 may be positioned on the outside of the processor housing, or positioned on packaging holding the processor. Further, in the case where processor 252 is integrated into a larger device, some of the structures may be placed external to the processor on supporting printed circuit boards, for example. It will be understood that the illustrated structures may be alternatively placed according to application specific requirements.

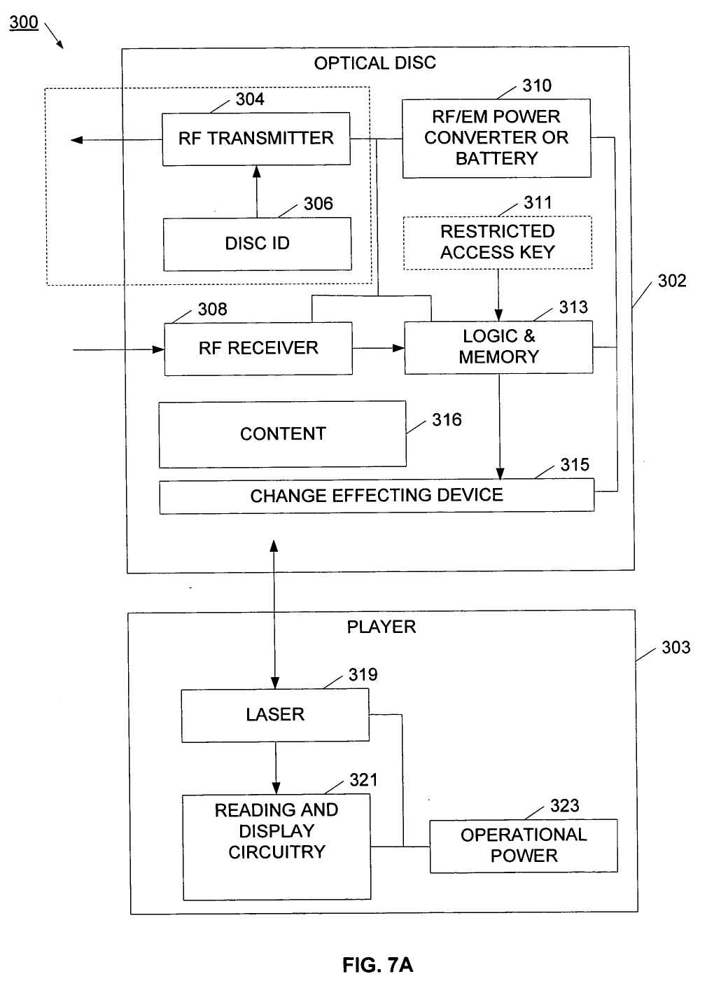

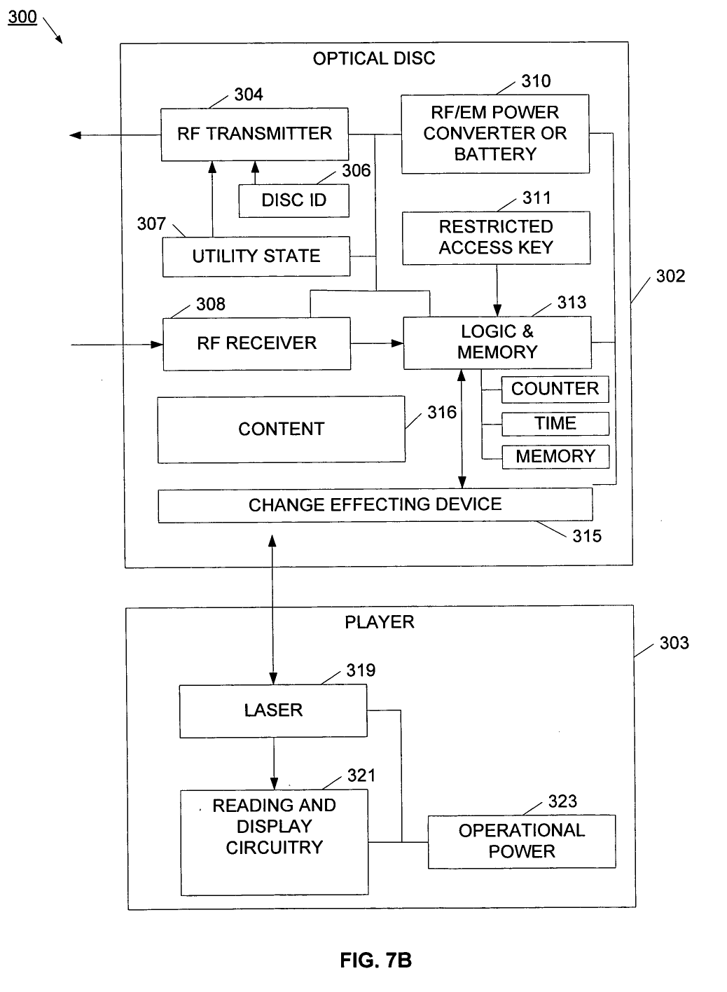

Referring now to FIG. 7A, a target constructed for use in a controlled distribution system is illustrated. Target 300 is constructed as an optical disc 302. Although target 300 is illustrated as an optical disc, it will be understood that other types of tangible medium may be used. For example, the target 300 may be constructed as a DVD, VCD, a credit card, a coupon, a ticket, a game cartridge, a readable memory, bottle, or other tangible media. Optical disc 302 has a primary use of having its content data being accessed by a player, drive, or game system. In this way, the utility of the disc is manifested in the ability of the player to perceive content stored on the disc. In a similar manner, a compromised disc would deny a player the benefit or reading or writing to the disc storage area.

Optical disc 302 has a content 316 which may include a content area, indexes, menuing, start data, or files and operational controls. This content 316 may be for example, a movie file, an audio file, a game file, or other information desired for viewing or use. The optical disc has a change effective device 315 which may be set into at least two states. In one state, the change effecting device interferes with the ability of a player 303 to read the content 316. More particularly, the player 303 has a laser 319 and associated reading and display circuitry 321 which is intended to read content 316. However, if change effecting device 315 has compromised utility of the disc, then the change effecting device 315 interferes with the ability of the laser light 319 to read index, menu, start data, or files or content information. In this way, the optical disc, when placed in its intended player, has fully compromised utility.

In one example, the change effecting device 315 may be an electrically switchable material. More particularly, the change effecting device may be an electrochromic material which changes optical characteristics upon the application of an electric signal. In this way, when the electrochromic material is generally opaque or highly refractive, laser light is interfered with to a sufficient level such that the reading and display circuitry of the player is not able to properly interpret the optical signals. However, when the change effecting device is changed to another state that is near optically neutral, then the laser is enabled to properly read indexes, menus, start data, or files, or content areas to fully utilize the optical disc.

The optical disc has an RF or other EM receiver 308 for receiving an authorization code. Logic 313 receives the authorization key and makes a determination as to whether the optical disc should be allowed to change state. In one example, the logic 313 uses a stored restricted access key 311 and compares restricted access key 311 to the authorization key received. Provided the keys match, then the logic takes the additional steps to cause the change effecting device 315 to switch to a different state. The optical disc also has a power source 310 for activating the logic 313, the receiver 308, and for affecting the change in the change effecting device 315. The power source 310 may be a battery stored with the disc or in packaging for the disc, or may be an RF/EM power converter which converts wireless energy for electrical use.

The change effecting device 315 may be used either to add utility to an optical disc or to compromise utility in optical disc. In one example, the optical disc 302 is manufactured with the change effecting device in a first state that fully compromises utility of the disc. This would allow the disc 302 to be moved through the distribution chain with a substantially reduced risk of theft. In this regard, anyone stealing or obtaining a copy of a stolen or unauthorized optical disc would not be able to use the optical disc in a commercial player. Accordingly, since the stolen disc has no or at least very limited utility, the risk of theft is substantially reduced.

At some point in the distribution chain, for example, at a point-of-sale terminal at a retail outlet, the optical disc may be restored to full utility. When placed near an activating device at the point-of-sale, the disc may receive a request for its ID 306. This ID may be a bar code, or may be stored in accessible memory location for transmission via a wireless communication. The disc ID in that case is transmitted by the RF transmitter 304 back the activation device. The activation device performs confirmation and authorization routines, possibly with a remote operations center, and determines if the optical disc is approved to have its utility restored. Upon such approval, the activation device transmits an authorization key to the RF receiver 308. Logic 313 uses a restricted access key stored with the optical disc. The restricted access key 311 was stored with the disc during the manufacturing process, and is associated with its disc ID 306. The activation device may request access to a file of associated disc IDs and authorization keys, which is typically securely maintained at an network operation center or other secure server location. In this way, the activation device may receive the restricted access key particular to disc 302. Provided logic 313 determines that the restricted access key 311 matches the received authorization key, the logic cooperates with power source 310 to change the state of the change effecting device to be in a near optically neutral condition. Accordingly, the optical disc now may be played or otherwise used in its respective player 303.

Referring now to FIG. 7B, the optical disc 302 is illustrated with some additional features. The disc illustrated in FIG. 7B is similar to the disc described with reference to 7A, so will not be described in detail. The disc illustrated in FIG. 7B is capable of performing the change in available utility as previously discussed. However, optical disc 302 has additional conditions which may be used to determine whether or not the change effecting device may be changed to a new state. For example, logic 313 has an additional input that allows for a counter input. This counter may be set to count the number of times a disc has been activated, and if a maximum has been reached, restrict any further restorations of utility. In another example, the logic 313 has a time signal, which may be for example, an elapsed timer, which provides an additional input signal. In this way, the optical disc may be restored to its full utility, and then the logic monitor for an elapsed time, and after a set elapsed time, return the disc to its compromised state. In this way, an optical disc may be activated for a preset amount of time. Logic 313 may also have additional memory space for performing logical functions, and for storing values needed for future determinations.

Disc 302 is also illustrated with a verification structure for verifying that the optical disc has changed state. In one example this verification system may take the form of a utility state circuit 307, which is used to transmit a current utility state through the RF transmitter 304 back to the activation device. In this way, the activation device may confirm that the optical disc is in its intended restored condition prior to a consumer leaving a retail location. In another example, the utility state 307 is configured to automatically transmit a signal upon a change in the change effecting device 315. The utility state 307 may determine that a change in state has occurred by monitoring or measuring one or more points in the activation circuitry within the optical disc. For example, the utility state circuit 307 may monitor the power supply and the associated powering circuitry to determine that sufficient power has been passed to the change effecting device 315 to accomplish a state change. In another example, the utility state may monitor the logic for determining that the state has properly been changed. In another example (not illustrated) the utility state may directly monitor the characteristics of the change effecting device 315, and report the current state of the change effecting device to the RF transmitter.

By reporting confirmation of a change, the activating device will be able to confirm that the optical disc has had a restored utility prior to the consumer leaving the retail location. Additionally, accurate reports and payment authorizations may be made within the distribution chain. It will be appreciated that other uses of the verification of changing utility state may be used.

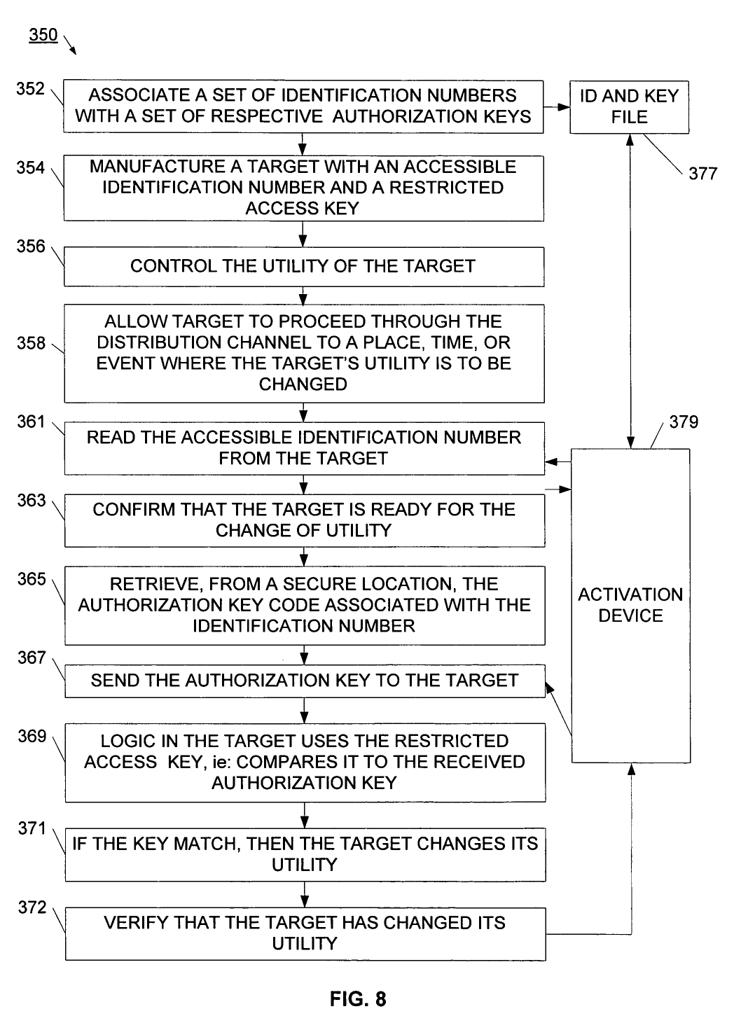

Referring now to FIG. 8, a method for distribution control is illustrated. Method 350 has a database or series of databases that associate a set of identifiers with a set of respective authorization keys. These identifications and keys may be distributed over several servers, on one server, or may be stored or generated at a local activation device. The identification numbers and authorization keys may have a unique one-to-one relationship, or may have a one-to-many relationship. For example, each and every optical disc may have a unique identification that has an associated unique activation code. In this way, a heightened set of security is enabled since only one authorization key can be used to restore utility to one particular optical disc. In another example, a single authorization key may apply to a set of identification numbers. In this way, a single authorization key may be sent to activate a range of products. Although less secure, such an arrangement may reduce network and authorization workload. In another example, the target may contain additional information from which an authorization key may be generated. For example, the date and time of manufacturing may be stored within an optical disc, and when read by an activation device, a secure algorithm generates the appropriate authorization key. In this way, only an entity with a secure and predefined algorithm is able to associate the accessible date and time information into the authorization key. The sets of keys and identification numbers are stored in a key file 377. These key files may be stored locally at a retail location, may be distributed to other servers within the same physical location, or may be distributed across different facilities and locations.

The target is manufactured with an accessible identification number and a restricted access key as shown in block 354. The accessible identification number may be stored as a barcode number, or may be stored in an area for interrogation by a wireless RF/EM system. In this way, an activation device is able to identify the particular target. The target also has a restricted access key which is stored in a nonvolatile, non-alterable, and non externally readable memory location. In a typical example, the restricted access key stored on a target is the same as the authorization key defined in blocked 352 above. However, it will be appreciated that other processes may be used. The manufacturer then controls the utility of the target as shown in block 356. For example, the manufacturer can fully compromise the utility of the target to make it unusable or nearly unusable, may set the target to a demonstration or limited operation mode, or may leave functionality enabled, and then disable utility later in the distribution chain. The target then proceeds through the distribution channel as shown in block 358. In the distribution channel, the target has only the utility that the manufacturer has enabled. In this way, the manufacturer is able to carefully control the use of its target until an authorized party has altered the utility of the target. Accordingly, at a place, time or event determined by the manufacturer, the target may be allowed to be changed to a different state of utility. In a common example, the target will be placed near an activation device at a point-of-sale terminal for a retail location as shown in block 361. The activation device 379 has a network connection to obtain ID and key file information, or has that information stored locally. The activation device communicates wirelessly to the target, through an RF or electromagnetic communication. The activation device 379 reads the accessible identification number from the target as shown in block 361. The activation device may perform other steps to determine that the activation device is approved to change the utility of the target as shown in block 363. For example, the activation device may cooperate with the point-of-sale terminal to determine that the consumer has paid for the target, or that the proper password has been entered by a consumer.

The activation device may also be authorized by the network operations center. For example, the authorization device may have an authorization ID or code which must be verified by the network operations center, or may be limited to be communicating from a specific communication port or device. In another example, activation device 379 may have integral GPS capability, and report its position location information to the network authorization center. In this way, the activation device must be in an expected location prior to authorizing the activation device to activate the target. Provided all the authorizations are received by the network operations center, the activation device 379 retrieves an authorization key associated with the identification number for the target as shown in block 365. The activation device sends the authorization key to the target as shown in block 367, typically using a wireless RF or EM communication process. The target receives the authorization key, and uses the restricted access key to compare the keys as shown in blocks 369. If the keys match as shown in block 371, then the target proceeds to change its utility by switching the state of a change effecting device.

In some cases the target may also have an internal circuit for verifying that the state has been changed. In such a case, the target may have an internal circuit for measuring or monitoring the state of the change effecting device, and report this state to the activation device as shown in block 372. This verified information may then be reported back to a network operations center for reporting and payment purposes.

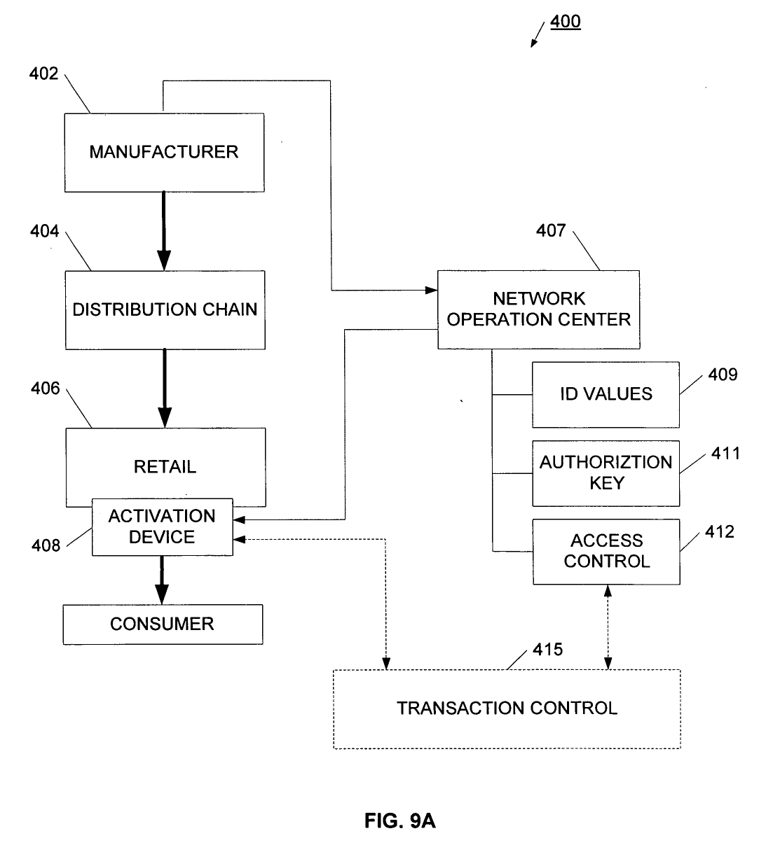

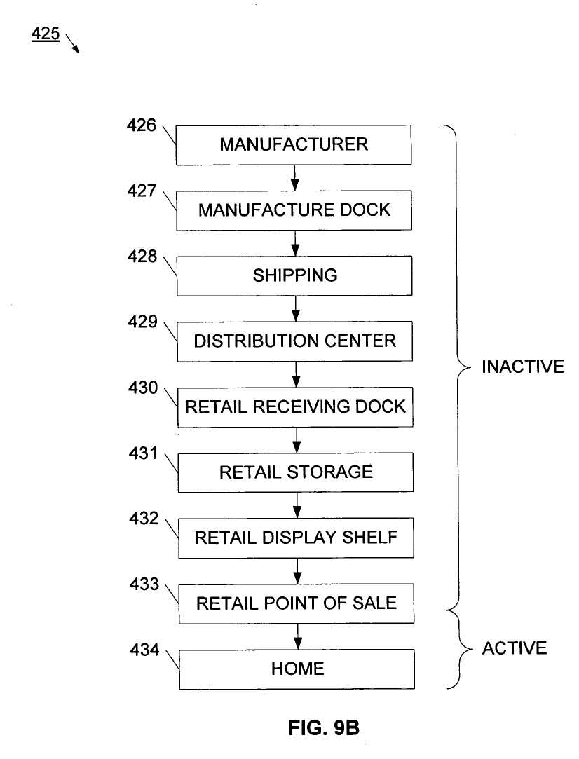

Referring now to FIG. 9A, a system for distribution control is illustrated. System 400 has a manufacturer 402 which manufacturers a target with a controllable utility. More particularly, the manufacturer constructs a target to have a change effecting device, which may change states according to a received authorization key. The manufacturer has a network communication link to a network operations center 407. The manufacturer uploads a list of ID values 409 which identify targets manufactured by manufacture 402 with the controlled utility. These identified targets have a set of cooperating authorization keys 411 useful for effecting a changed utility that are also uploaded by manufacturer 402 to the network operations center 407. A target may be associated with more than one key, with each key capable of setting a different level of utility. The manufacturer may also be allowed to set additional access controls 412 for devices. For example, the manufacturer may restrict the sale of particular target to a particular geographic location or country. In another example, a manufacturer may not want a particular DVD movie to be activated in a specific country until after a target date. In this way, a manufacturer may maintain control of its target even when it passes the target into the distribution chain 404.

The distribution chain 404 may include several entities, including shippers, truckers, warehousers, distributors, and other distribution entities. The distribution chain 404 accepts the controlled target for manufacture 402 and passes the controlled target to a retail environment 406. Accordingly, during the entire time the distribution chain 404 has possession of the target, the target was in a controlled level of utility. More particularly, the manufacture has been able to control the available utility in the device through almost the entire chain of distribution. The retail entity 406 has an activation device 402 useful for changing the utility of the target. The retail establishment may determine under what events, at what place, and at what time to change the utility of the target. For example, some retailers may choose to change utility at a point-of-sale terminal as a customer purchases a product, while others may choose to activate as a target enters the retail store. Further, different products may be activated at different times. For example, large durable electronic devices such as big-screen TVs may be difficult to steal from a retail environment, so may be activated at the shipping dock. However, an optical disc, which is easily hidden and removed from the store, may only be activated at a point-of-sale terminal after confirmation of payment.

The activation device 408, whether it is at the point-of-sale or another location, wirelessly communicates with a target to obtain target identification information, and to send an authorization key to the target. In performing these operations, the activation device communicates to a network operations center 407. The network operations center has access to the ID values 409, authorization keys 411, and any additional access controls 412. These additional access controls 412 may include further authorization and security controls for the activation device 408 itself. For example, the activation device 408 may have an identifier that must match a predefined identifier prior to authorizing the activating device to operate. In another example, the activation device 408 is expected to communicate on a particular predefined communication network, for example a specific TCP/IP port. If the activation device 408 communicates on an unexpected port, then the activation device may be in an unauthorized location being operated by an unauthorized person, and therefore the network operations center will not send any authorization keys. In yet another example, activation device 408 has integral GPS capability, and can report its position location information to the network operations center 407. If the activation device 408 is not in an expected physical location, then the network operations center 407 again will not send the authorization key. This is useful, for example, if an activation device is stolen or removed from its intended location, and a thief is trying to activate targets at another location.

The access control module 412 may also communicate with transaction control system 415. Transaction control system 415 may be associated with the network operations center 407, may be located at the local retail store, or may be a remote and under the control of a third party. For example, transaction control 415 may be a credit card authorization company that receives a credit card authorization request from activation device 402, and sends an authorization confirmation back to the activation device. In this way, the activation device 408 may not proceed to activate the target until confirmation has been received from the transaction control subsystem 415. The authorization requests may also include requests for checks, check cards, debit cards, and other financial instruments. The transaction control may also include verifications of passwords, membership, security clearance, age, biometric data, or other confirmation values.

The activation device 408 may also receive a verification signal back from the target that the target has been properly activated. In such a case, the activation device may communicate the successful change to the network operations center 407 or to the transaction control 415. In this way, reports and payment authorizations may be made responsive to notification of a successful utility change.

Referring now to FIG. 9B, a simplified distribution chain is illustrated. In this distribution chain, a manufacturer 426 manufacturers a target with controlled utility. The manufacturer ships the target out of its manufacturing dock 427, and the target is received at the shipping port or dock of the distribution center as shown in the block 428. The distribution center 429 may ship the product to a retailer where it is received at the retailer's receiving dock as shown in block 430. The retailer may place the target in the storage 431, and then move the target to a display shelf within a retail environment as shown in block 432. At this point, the target may be available for handling by a consumer, and the consumer may move the target towards a point-of-sale checkout terminal 433. A retail clerk typically takes the target and scans the target using a wireless RF/EM activation device. The activation device identifies the target, and retrieves an authorization code specific for that target. The clerk and point-of-sale terminal cooperate with the consumer to receive payment and provide any other needed information, such as age or password, or membership affiliation. Up to this point, the target has been in the utility state selected by the manufacturer. At a point approved by the manufacturer and selected by an authorized retailer, the manufacturer allows the authorization key to be sent. In this way, the manufacture may maintain control over when, where, and under what conditions the target may sold to a consumer. Accordingly, the manufacture may allow the authorization key to be sent only after a particular date or time, to a particular geographic region, or to a particular age group. In one example, the manufacture and retailer use a network operation center to coordinate the required approvals and effectuate the delivery of the key to the activation device. The retailer then uses the authorization key to place the target into a second state of utility. The consumer is then able to take the target home as shown in block 434, and has the device operating in its second state.

In one example, the manufacturer manufactures a target with a fully compromised utility. The fully compromised target is transferred through various shipping docks, distribution centers, storage, display shelves, and shopping carts before it is received at the point-of-sale terminal. Through this entire process, the target has a substantially reduced risk of theft, as target has little to no utility if stolen. In this way, the manufacturer has successfully controlled the distribution and use of its product from the point of manufacture to the point-of-sale terminal, irrespective of how many entities had possession of the target in-between. Once the retailer activates the target, the consumer is then able to use the target with full utility.

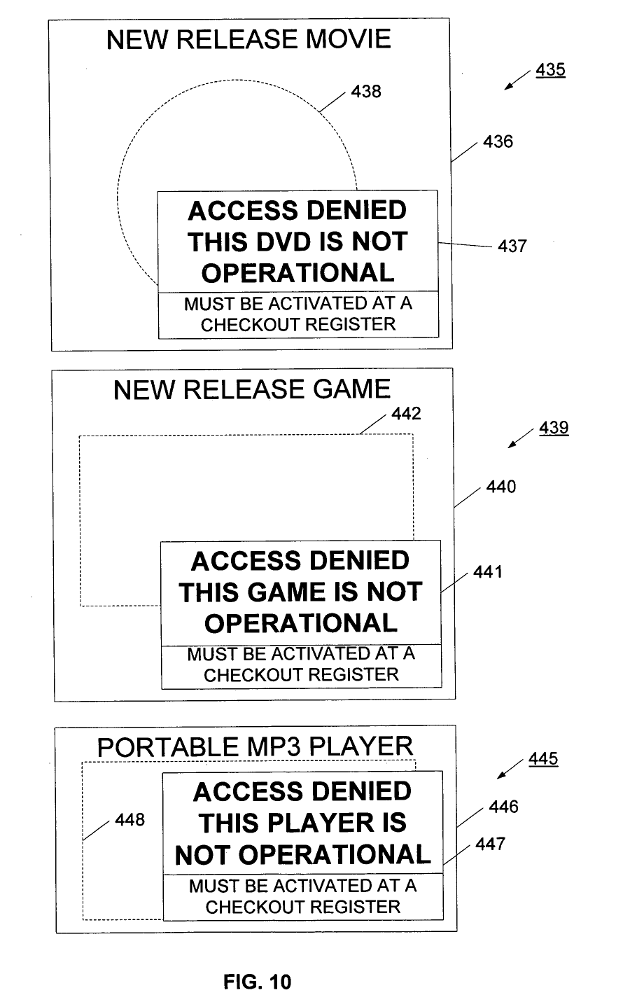

Referring now to FIG. 10, a controlled display package 435 is illustrated. Controlled package 435 has a packaging 436 holding a controlled optical disc 438. The package 436 has a prominently placed indicia in the form of a label 437 for clearly identifying the disc as having controlled utility.. Since the utility of the disc has been fully compromised, customers, employees, and any potential thieves are notified that the DVD is advertised as being not playable in its associated consumer player device until it is activated at the checkout register. Accordingly, by providing a controlled target 438, and by prominently labeling the target as not playable, the risk of theft is substantially reduced.

In a similar manner package 439 shows a new release video game in a compromised configuration. Game 442 has been compromised to be not playable and the game package 440 is prominently labeled 441 with indicia indicating that the game is not playable. Accordingly, the risk of theft is substantially reduced as the game cartridge would not be usable in its intended player. As a final example, a portable MP3 player 445 is shown in its packaging 446. The MP3 player 448 has been fully compromised so is not in an operational condition. A label 447 is attached to the packaging 446, prominently indicating that the MP3 player does not operate. In this way, theft is reduced as the utility for the MP3 player would not be available on a stolen device.

The controlled target has primarily been described and illustrated with reference to a commercial transaction, such as the sale or transfer of a target to a consumer. However, it will be appreciated that the controlled target may be used in other fields and applications. For example, the controlled target may be used in military or other governmental applications to control the distribution and use of devices and media. In this way, a device or media may be stored and shipped in a compromised or limited utility, and then restored to full or selected utility at a controlled time and place. In a specific example, a weapon may be manufactured, stored, and shipped with its destructive capability disabled. When the weapon is delivered to the battlefield distribution point, an authorized weapons officer uses an activation device to restore the weapon to full operational capability. The activation device may cooperate with a secure network operation center to assure that the weapon is being activated at an approved location, at an approved time, and by an approved officer. A similar controlled system may be used for other electronic and media targets.

Referring now to FIG. 11, a controlled electronic target device 450 is illustrated. Electronic device 450 is an electronic device having a case 452 for enclosing and protecting the utility means and other operational circuitry and devices. In one example, case 452 is metallic, and therefore restricts wireless communication to components' and circuitry within the target. In this way wireless communication to devices and components inside the target would require an unduly strong RF or EM signal to robustly and effectively communicate. To improve the effectiveness of wireless communication, an antenna member 455 is installed external to the case 452, and electrically coupled to activation circuitry within the housing 452. In this way, the antenna may be readily accessible for wireless communication with an activating device, while still maintaining the change effecting device within the target housing 452. In a particular example, a connector 453 is positioned on housing 452. This connector may be a connector specifically designed for antenna 452, or may be an existing connector for the target. For example, if the target is an audio device, the target is likely to have several; existing audio connectors. In another example, target 450 may be powered through an AC or DC external power connector. In this way, the connector 453 may be a power plug or adapter input. It will be appreciated that other types of connectors, such as Ethernet data ports, serial data ports, USB connections, and other standard audio, video, and data connector types may be used.

In use, antenna 455 is attached to connector 453 during the manufacture or the shipping process. At the point-of-sale environment, an activating device cooperates with the antenna 445 to send and receive information and power to and from circuitry within the target enclosure 452. In particular, the antenna may receive a request for an identification value and transmit an identification value to the activation device. The activation device, after performing its authorization routines, may then send an authorization key through the antenna 445 into the target. The target has logic coupled to the antenna through connector 453 which determines that it may change its change effecting device to another state. After the state of utility has been changed, the target may report the verification of the change through the antenna 455 back to the activation device. Typically, at this point a consumer will transport the electronic device 450 to another location, and place the electronic device in an operable state. The consumer may remove the antenna member 455 and dispose of it. In another example, antenna member 455 is integrally formed with the case 452 and may remain on the case.

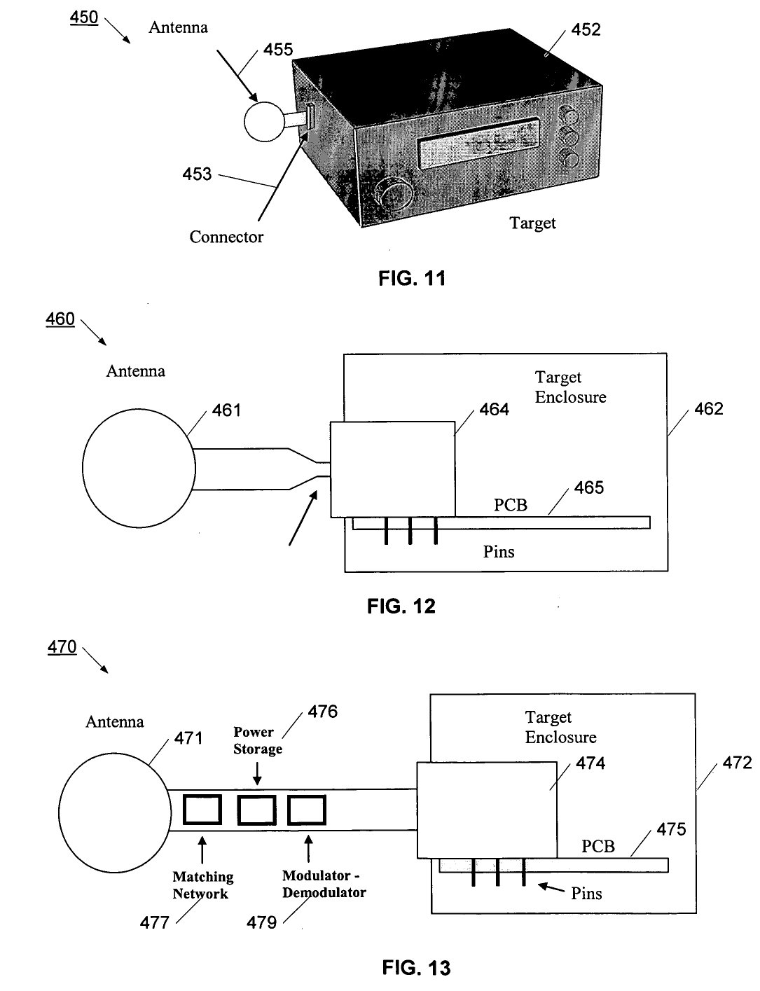

Referring now to FIG. 12, one example of the antenna member is illustrated. In FIG. 12, the target enclosure 462 encloses a printed circuit board 465 on which the change effecting device, logic, and support circuitry are positioned 464. An antenna member 461 is coupled to the internal circuitry 464 through a connector. It will also be appreciated that the logic and change effecting device may be positioned with the antenna member or the connector. In this way, while internal circuitry 464 is shielded from RF and EM communications, antenna 461 is externally positioned for ready communication. Although antenna member 461 is shown having only the antenna structure external to the target enclosure, it will be appreciated that other parts of the internal circuitry may be moved external. For example, a power source in the form of an RF/EM converter may be provided on the antenna member 461, as well as a battery. In another example, some or all of the logic may be moved to the antenna member, as well as the restricted access storage for a target key. Of course, this latter configuration may be less secure, but may be useful to some applications. Typically however the change effecting device will remain within the target enclosure due to its coupling to utility means, which are within the target enclosure.

FIG. 13 shows another example of the antenna member 471. In this example, the housing 472 has a printed circuit board 475 holding internal circuitry 474. Controlled system 470 is particularly useful when using an existing audio, video, data, or power connector on the target. For example, it may be desirable to use an audio connector to connect antenna 471. However, the internal audio circuitry is typically constructed to operate at relatively low frequencies, for example less than 100 kHz, and in some cases may be designed to operate at less than 30 kHz. Accordingly, the otherwise desirable 900 megahertz or other radiofrequency signal received by antenna 471 may not be robustly or effectively communicated into the internal circuitry 474 when at a radio frequency. Accordingly, the radio frequency signal is demodulated to a lower frequency using the modulator-demodulator 479. For example, the antenna may receive a 900 MHz RF communication, and demodulate that signaled into the lower frequency signal capable of being transmitted through the audio level circuitry. In this way, a relatively low-frequency signal may be received by the internal circuitry 474, and used to change the state of the change effecting device with in the housing 472.

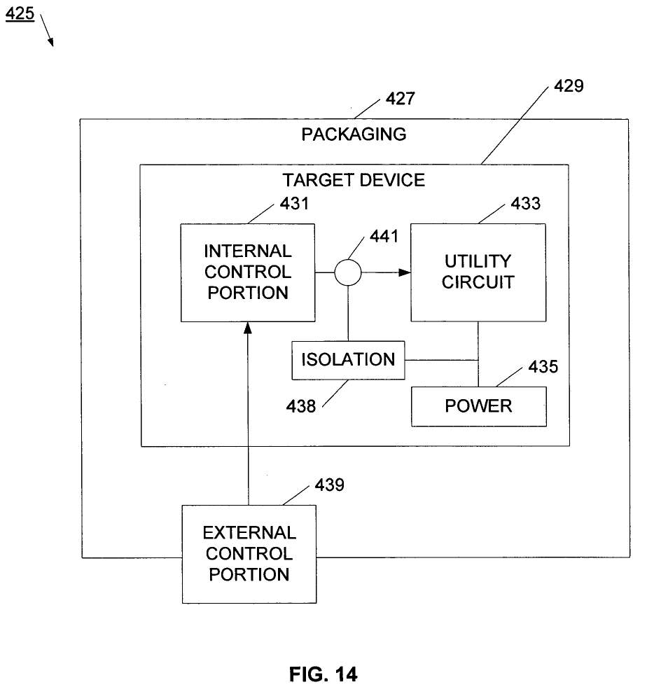

Referring now to FIG. 14, a target having controlled utility is illustrated. Target 425 has a target device 429 enclosed within packaging 427. If the target device 429 is an electronic device, the packaging 427 may be, for example a case or shipping box for the target device 429. In an example where the target is tangible media, the packaging may be a case, such as an Amaray case for DVD's, or a jewel case for CD's for holding the media. In some cases, the target may interfere with wireless communications. For example, even though the plastic media case does not normally interfere with wireless communications, the metal layers of the disc may, so it may be desirable to position the external control portion 439 on the inside of the packaging 427, and external to the disc. Accordingly, an external control portion 439 is attached to the target 429 to enable more efficient and effective wireless communication. Depending on the particular target and packaging, the external control portion 439 may be attached to the inside of the packaging, be attached to extend through the packaging, or be attached to the outside of the packaging. The external control portion is connected to an internal control portion 431 for controlling utility of the target. One or both of the internal control portion and the external control portion may have a power source for activating and operating the control circuitry. For example, the external control portion 439 may include an RF/EM converter device, and the internal control portion may include a battery. The target device may also include an operation power supply 435. To protect against damage of internal circuitry, an isolation circuit 438 may couple to a switch 441. In this way, utility means 433 is protected from the electrical signals operating with in the internal control portion 431, and the internal control portion may also be protected from power supplied by power source 435. In one example, the isolation device 441 is a switch that decouples the internal control portion 431 from utility means 433 when operational power 435 is activated. It will be appreciated that more sophisticated isolation processes and devices may be used when additional protection is needed.

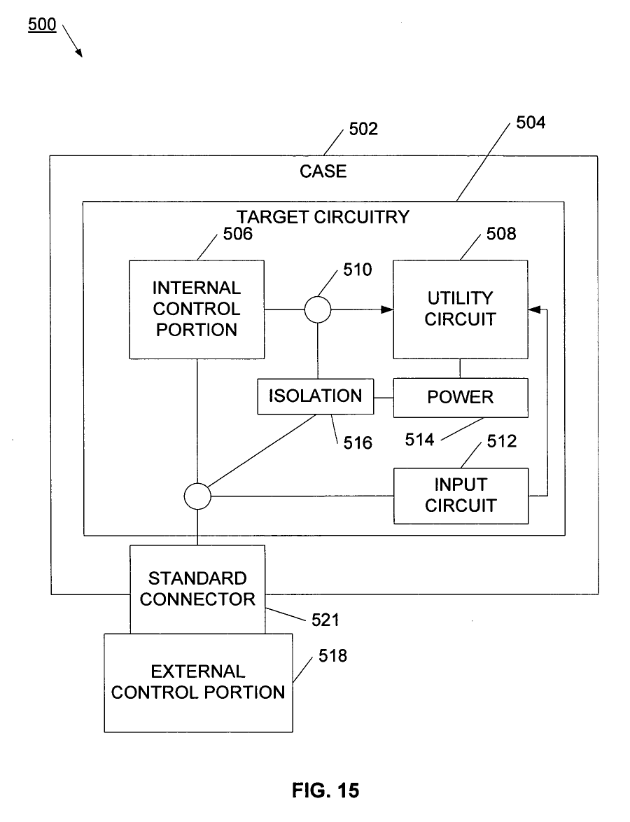

Referring now to FIG. 15, a target with controlled utility is illustrated. Target 500 has target circuitry 504 arranged within a housing or case 502. Case 502 may interfere with communication to target device 504, so portions of the utility control circuitry are advantageously placed external to the target housing. A standard connector 521 is positioned on the case 502, and an external control portion 518 couples to the standard connector 521. The external control portion has RF/EM antenna structures, as well as associated communications circuitry. For example, the standard connector 521 and its associated internal circuitry may not be constructed to operate at a radio frequency. Accordingly, the external control portion 518 may include demodulation circuitry for reducing the frequency of the received signal. In this way, the received radio frequency signal may be demodulated to a frequency that may be effectively and robustly communicated within the target device circuitry 504. The external control portion 518 cooperates with an internal control portion 506 for effecting a change in utility of the target device. More particularly, the change effecting device is coupled to the utility means 508 for enabling a particular level of utility. Since the activation signals are present on connector lines used for utility purposes, isolation and protection of utility circuits becomes important. In this way, additional circuitry may be provided. For example, an input circuit 512 may be provided that is coupled to the connector 521 only when the activation circuit is not active. It will be appreciated that many alternatives are known for providing isolation.

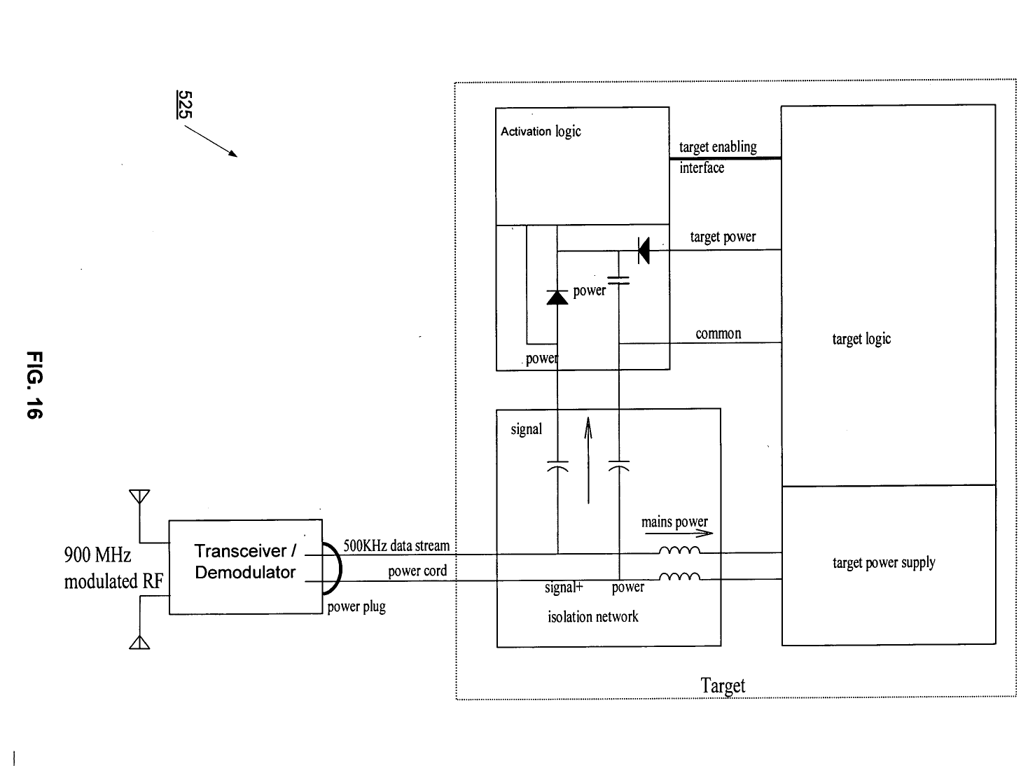

FIG. 16 illustrates an electronic device with an external antenna member coupled to an AC connector or power cord. It plugs unto the prongs of the pendent AC power cord. With an appropriate physical connector the same design could be used for an IEC power entry connector. In this embodiment, the transceiver/demodulator converts the incoming modulated RF (e.g., 900 MHz) signal into a lower frequency (e.g. ˜500 KHz) demodulated data stream using appropriate digital encoding techniques. This low frequency (˜500 KHz) demodulated signal is coupled to the power cord connector on the target. The isolation network which separates the activation data stream from the target power input module, is connected between the AC power connector, and the target power supply. It consists of 2 inductors and 2 capacitors. These components are selected based on the frequency ratio between the signal frequency used by the target connector, (in this example 60 Hz), and the activation frequency being used, (˜500 KHz). At 500 KHz, the inductors present a high impedance to the activation signals, while the capacitors present a low impedance. Thus, the activation signals couple to the activation circuitry, and the low power supply impedance is isolated by the inductors. When the target is powered by 60 Hz, this situation reverses. The inductors look like a low impedance and couple the 60 Hz energy to the supply, while the capacitors look like a high impedance to the 60 Hz energy, and prevents the 60 Hz from coupling into the activation circuitry.

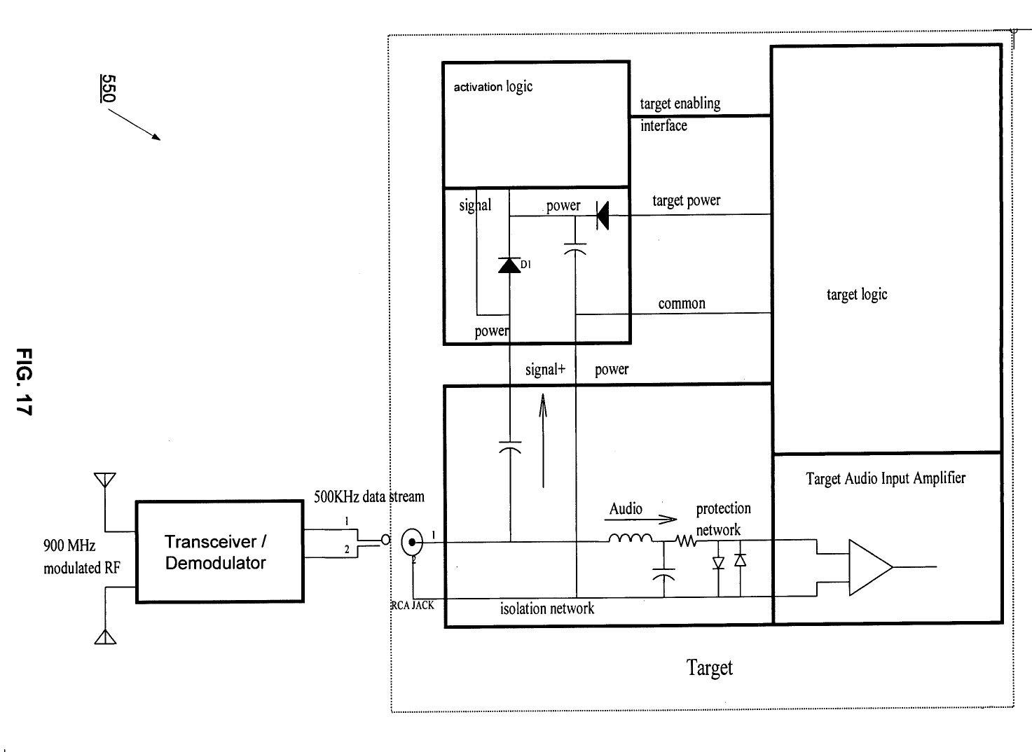

FIG. 17 illustrates an electronic device with an external antenna member coupled to an audio input port. Audio signals require bandwidths as high as 20 KHz, which means that the ratio of the activation signals to the audio signals is less than for the previous 60 Hz power example. This lower ratio may require a more complex filter topology in order to achieve the required isolation of the signals. In this example a shunt capacitor in addition to the inductor has been added in the audio path. This results in a filter with more attenuation (sharper cutoff characteristic) for the activation signals. Since the audio input can be low level, additional components may be added to prevent damage to the audio input stages. A simple dual diode clamp with an appropriately sized resistor can accomplish this. When the target is powered in the normal operational state, the activation power diode D1 is reverse biased by the target power, and thus presents a high impedance to the audio signal. This isolates the activation circuitry from the audio signal, as well as isolating the audio circuitry from any noise sources in the activation circuitry.

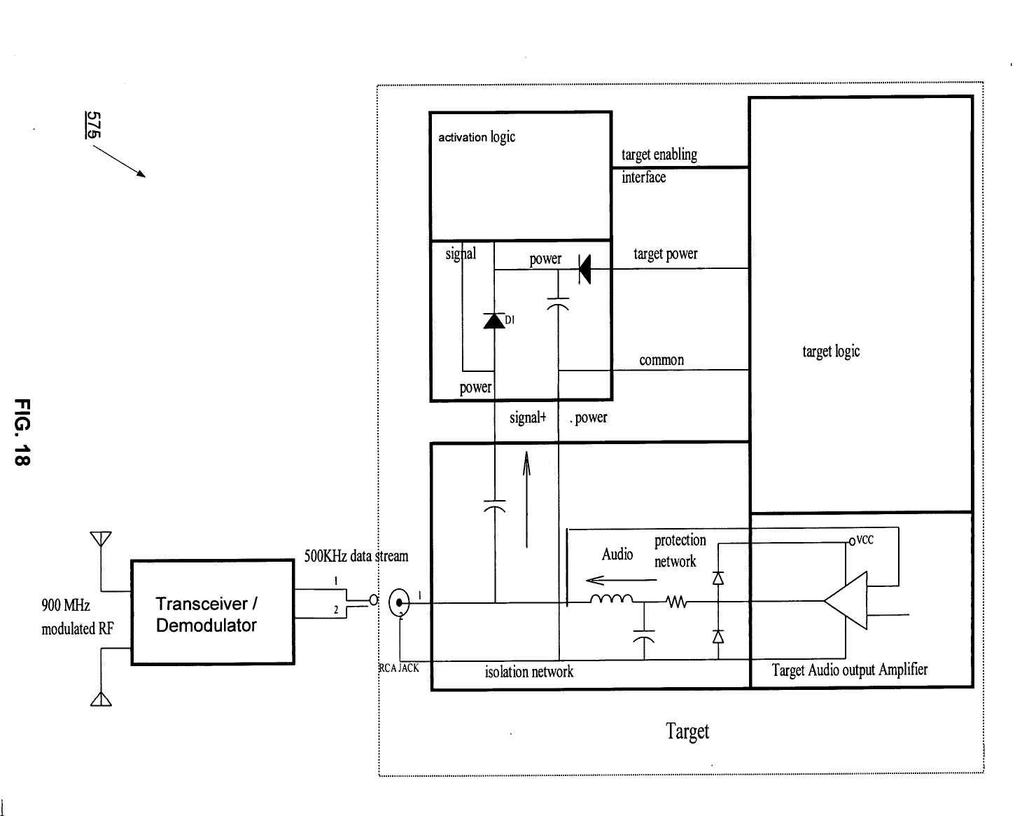

FIG. 18 illustrates an electronic device with an external antenna member coupled to an audio output port. As described in FIG. 17, the filter topology may be more complex at audio frequencies. In this case since the connector is an audio output, a different topology is required to protect the audio output circuits from overload. Although a simple 2 pole LC filter is shown, more poles may be required in order to achieve the required isolation of the activation signals without affecting the audio frequency response. Also, it may be desirable to include the isolation filter within the feedback loop of the audio output amplifier as shown in order to minimize the impact to the audio frequency response.

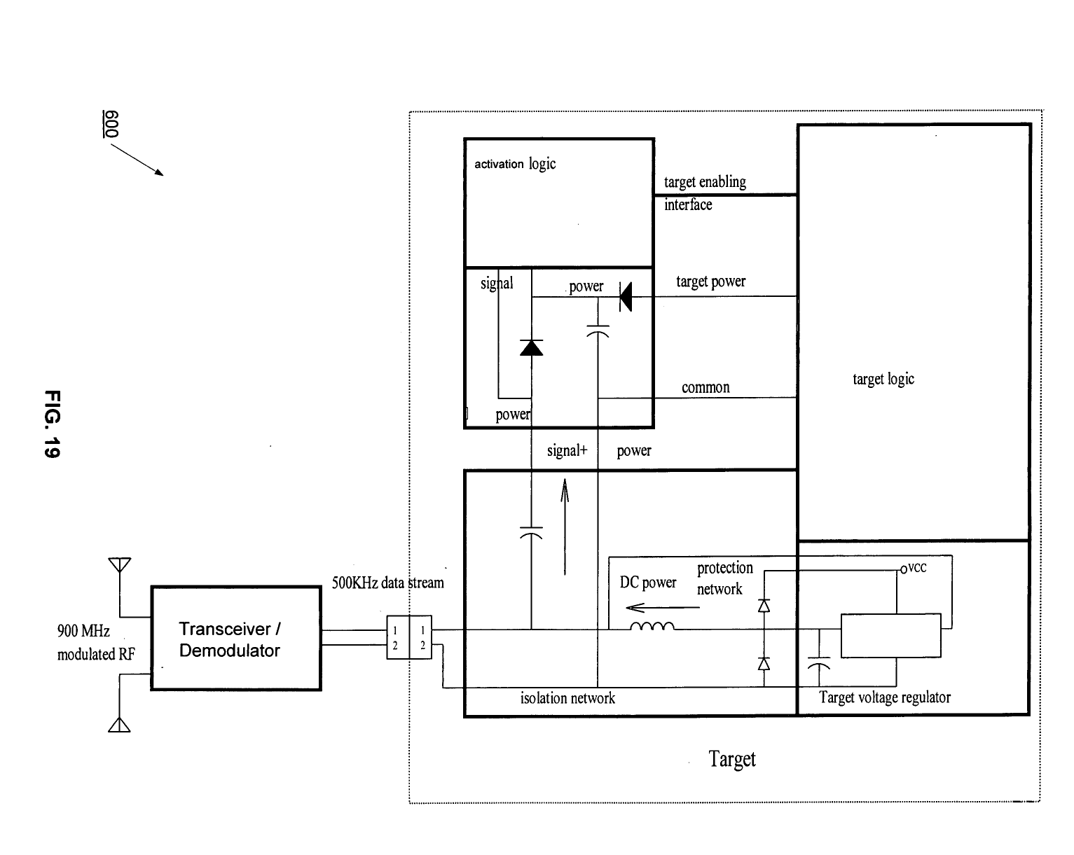

FIG. 19 illustrates an electronic device with an external antenna member coupled to a device which provides a source of DC power for other devices, i.e. Power-Source Equipment (PSE). Because of the large output capacitance associated with sourcing DC power, the isolation network may not require its own filter capacitor. The added inductor in combination with the PSE output filter capacitor, form the isolation network to keep the target circuitry from loading the RFA signal. As in the case of the audio amplifier output, it may be desirable to include the isolation network in the feedback loop of the output voltage regulator thereby minimizing the effect of the isolation network on the normal operation of the power sourcing equipment.

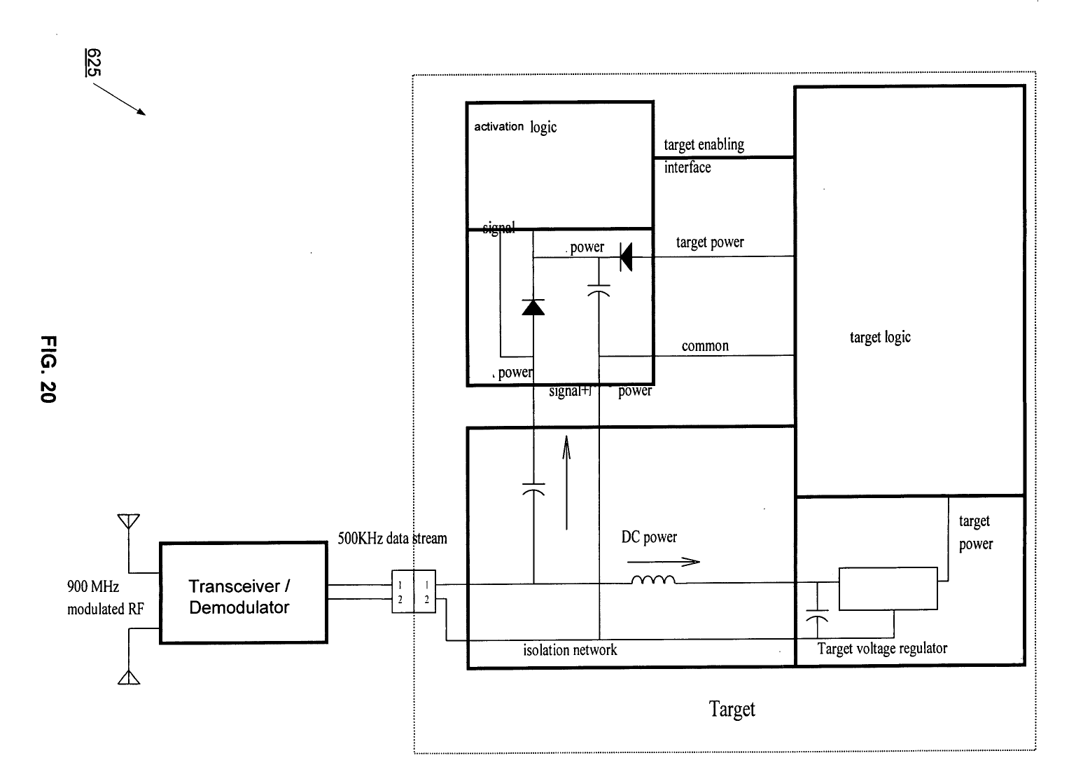

FIG. 20 illustrates an electronic device with an external antenna member coupled to a target which is powered by an external DC supply, such as an AC wall socket regulated DC supply. This type of target is referred to as a Powered Device (PD). As shown, the isolation network for the target power supply consists of a single inductor. The target power supply's input filter capacitor is used with this inductor to form a low pass filter which provides a high impedance to the activation signals, and keeps the activation signal out of the power supply circuitry. When the target is powered by an external DC source in normal operation, the inductor helps attenuate external high frequency noise. Because the input filter capacitor will normally be quite large, (high capacitance), clamp diodes may not be needed.

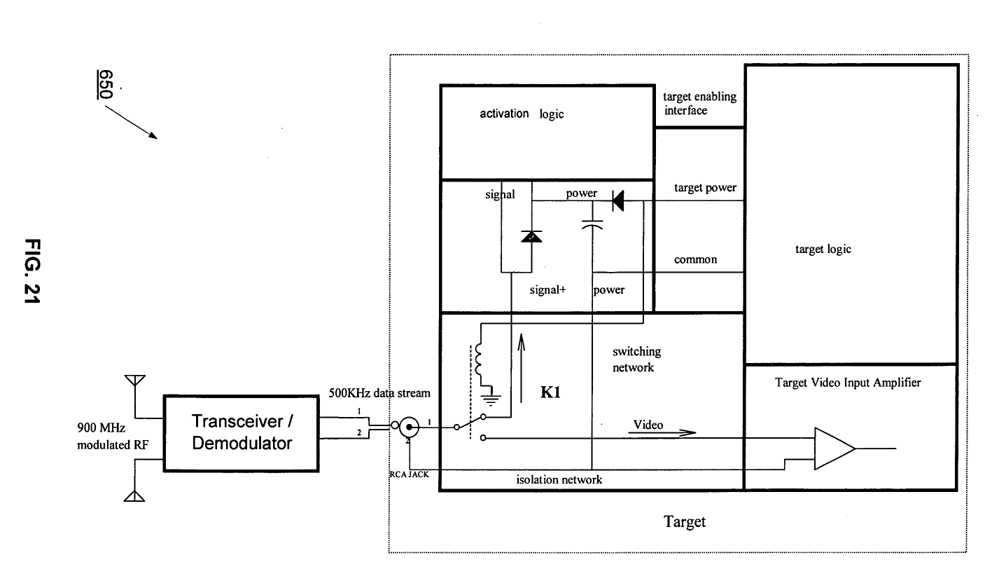

FIG. 21 illustrates an electronic device with an external antenna member coupled to a video input. Because video signals overlay the activation signals in the frequency domain, passive filter isolation networks are not effective at isolating the signals. In these situations, isolation may be achieved by a switching device such as a relay or solid state switch, which is energized by target power during normal target operation. During activation, when the target is un-powered, relay K1 routes the activation signals to the activation circuitry. When the target is powered, it energizes relay K1, which routes the video signal to the normal target circuits rather than the activation input. This provides a very high degree of isolation between activation signals and target circuitry. This approach is feasible in all systems in which the connector being used is not the source of power for the target. It may be desirable to use a solid state switch rather than a relay to accomplish signal switching. In these cases, two solid state switches may need to be connected back to back in series so that their substrate diodes do not conduct when the target is powered off, and activation signals are present.

Many other target connectors can be utilized as the activation signal port using the techniques described above and depicted in FIGS. 16 to 21. Many connectors have unused pins, which can be used for activation signals without any isolation networks. Connectors which fall into these categories include, but are not limited to: USB ports, Ethernet ports, mouse ports, keyboard ports, PCMCIA ports, memory card ports, S video ports, game ports, serial ports, parallel ports, phone jacks, and battery connectors.

As demonstrated by the foregoing, there are a multitude of everyday situations that would benefit from a secure method and system for effectuating a change in the utility of an item (“target”) upon the realization of certain conditions (i.e. a customer has paid for the product). As the following examples illustrate they range from renting movies and video games at home to preventing theft in the manufacturer-to-retailer supply-chain. To facilitate adoption by manufacturers, retailers and consumers a method and system that works with targets that are always operable (e.g. a DVD) as well as targets that are in an inoperable state (e.g. a DVD player in a sealed cardboard box) is highly desirable.

Novel methods and systems are provided herein for effectuating changes in a target that affects its utilities. The target can be in either an operable or an inoperable state. The changes are effectuated by means incorporated into the target. The changes are conditioned on communications that can be received from a proximate activation device. Methods and systems are described for effectuating transactions that effectuate changes in a target that affect its utility. The target can be in either an operable or inoperable state. The changes are effectuated by means incorporated into the target; and where the effectuation of the changes are conditioned on communications received from a proximate activation device. Methods and systems are described herein for effectuating changes in a target that restore its utility where previously the target's utility was deliberately compromised. The target can be in either operable or in an inoperable state. The changes can be conditioned on communication received from a proximate activation device.

In one example, a manufacturer ships a product (target) incorporating a public identifier (“target ID”) and an associated private key (“target key”) and “a mechanism for effectuating a change” in the target. The manufacturer separately communicates the target ID and target key to a network operations center (“NOC”). At the manufacturer or later, the target's utility is deliberately compromised. This may be done for a multitude of reasons such as to deny benefit to a thief if the target is stolen prior to purchase or to enable new forms of commerce (e.g. new rental models). To restore the target's utility, the target is placed proximate an “activator”: a device communicatively coupled to the target. The activator acquires the target ID and communicates it to the NOC. The NOC uses the target ID received from the activator to lookup the associated target key. The NOC communicates the target key to the activator which in turn communicates it to the target. The target receives the target key from the activator, which a mechanism in the target uses to conditionally effectuate changes in the target which restore its utility; the condition being receipt of the target's private key.

Conditions that are met to effectuate a change in a target may be realized at the target and logically coupled to include one or more conditional events at devices external to the target. For example a target (e.g. a calculator) may require a target key wirelessly transmitted from a proximate activator to close an internal electronic switch and allow power from the target's batteries to power-up the unit. If an appropriate target key isn't received and the switch remains closed, the unit doesn't work (the target's utility remains compromised and benefit is denied the possessor of the target). The ability of the activator to obtain the appropriate target key from a NOC may be conditioned upon being first able to interrogate the target and obtain the target ID. The ability of the activator to transmit to the target a target key obtained from the NOC may be further conditioned on the consumer having paid for the target first. The activator's ability to transmit a target key is therefore conditioned on first receiving notification that payment has been made from a “linked system” (i.e. a cash register or other payment system).

The NOC may also use the target ID to look up information other than the target key that is pertinent to the activation transaction (i.e. manufacturing lot numbers, ship dates, release dates, prices or decision rules related to the transaction etc.). The NOC may then effectuate one or more transactions and send one or more communications particular to the target (or target and activator). Communications from the NOC or activator may also be communicated to/from linked systems (e.g. a payment processor) and/or to a distributor or manufacturer (e.g. for billing and inventory management purposes), retailer etc. The communications described herein (e.g. communication 751 in FIG. 8) may be one or a combination of passive (e.g. a bar code) and active (e.g. RF transmission or electrical signal); include one or more data components (e.g. a device identifier and an IP address) organized into one or more separate (dependent or independent) communications. Communications may include data (or information; in analog or digital forms) and/or power. Communications depicted in the drawings herein may be shown as one or more symbols (arrows) to emphasize the flow of data and power. The number of symbols however should not be construed as to define or limit the number communications between two items or the number of data or power elements therein.

Generally, a target is a tangible item as opposed to data or content. An optical disc for example is a target, but the content (e.g. software, movies, music etc.) stored within it is not. All targets have an operable state (e.g. a DVD or a DVD player once it is plugged-in). Many targets, including most devices that rely on electrical power, also have an inoperable state (e.g. a DVD player while it is still in the box and without power). Targets may also be active or inactive. An inactive target is deliberately compromised in one or more ways that affects its utility. An active target is one where it's utility (entirely or elements thereof), has been restored or recreated by effectuating changes in the target.

Activating a target is the process of restoring or recreating its utility. A target incorporates “an activation mechanism” or means for this purpose that functions independent of the targets operable or inoperable state. A target therefore can be activated independent of its operable or inoperable state. The effector (change effecting device) that compromises a target's utility may be reversed, repeated or permanently altered. In some embodiments, the effector (and the compromise) may also be negated, partially or entirely, using other means (e.g. bypassed). The effector (change effecting device) that compromises the target's utility may be of one or more kinds. An effector for example could be an open electronic switch in a circuit connecting a DVD player's on/off switch to its power supply. Another example of an effector may be a thin electro-optic film layered onto a DVD that interferes with DVD players' ability to read the content stored within. Another example of an effector could be logic or data, and the store thereof.

The effector (change effecting device) that compromises the target's utility may be effectuated by the manufacturer prior to shipment although in some cases it may be effectuated by a distributor or systems integrator. It may also be effectuated automatically (repeatedly) once the target is in a consumer's hands as in the case of a self-deactivating optical disc where the thin-film automatically reverts back to a state where it interferes with DVD players' ability to read the content after a period of time (e.g. a rental period).

Targets can be consumer electronics and computer products (DVD players, video game players and consoles, televisions, digital cameras, phones, personal digital assistants (PDA's), batteries, calculators, computers, printers, fax machines, monitors, portable music and video players/recorders, car stereos etc.), appliances and tools (particularly those with electronic controls), watches etc. Targets may also be media such as optical discs (e.g. CD's and DVD's), for example, enhanced with a mechanism for changing their optical properties. Targets may also be components of systems and replacement parts (e.g. hard disc drives, memory cards etc.). Targets may also be instruments, machinery etc.

The utility of a target is often its primary use (e.g. a radio to play music; a printer to print; an optical disc to store data that can be accessed by a player or drive etc.). For the purposes of this document, the term utility should also be construed to mean any use, function, feature, etc. of the target. The utility of a target should also be interpreted to mean any benefit derived from an item (including the perception thereof); and especially benefits that if denied would affect the use or value of the target.

A target incorporates an activation mechanism to conditionally effectuate one or more changes in response to one or more external signals. Some or all of the activation mechanisms may be supplemental to the original product. They can also be partially or wholly removable. In general activation mechanisms include communication mechanisms, conditional logic (“logic”), memory, means for effectuating changes, a power supply, and a public target identifier (“target ID”). Activation mechanisms can also have a hidden or private key (“target key”) and other elements as necessary to execute activation transactions (e.g. a mechanism to determine the activation status of a target). In certain cases, activation mechanisms can include only memory containing a target ID, means for effectuating changes and a power supply; or only means for effectuating changes and a power supply.

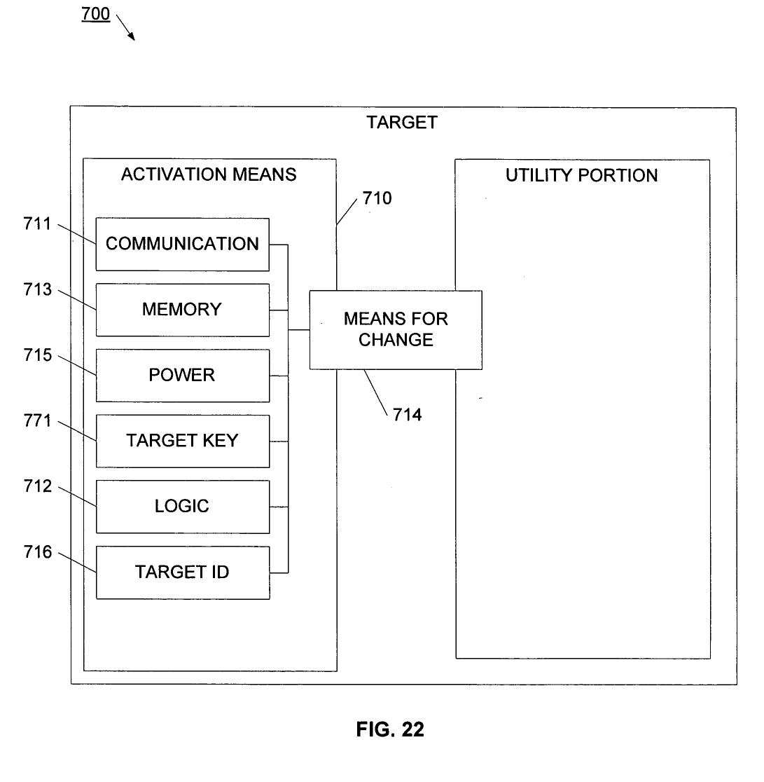

The components of the (e.g. communication means, power supply, target ID etc.) are typically added to the target although they may be in whole or in part be implemented using components already common to the target. For example the existing battery in a calculator may function as power supply obviating the need for either an additional battery or a means of receiving energy from an external source. FIG. 22 shows a diagram of a target 700 incorporating activation mechanisms 710 consisting of
Communication means 711
Logic 712
Memory 713
Means for effectuating changes 714
Power supply 715
Target ID 716
Target key 717

Communication means 711 effectuate communications consisting of data or power with external devices. Communication means 711 can be one or more wired or wireless systems: e.g. infrared “IR” and radio frequency (“RF”) transmitter/receivers. Communication means 711 may also support unidirectional or bidirectional communications. Logic 712 consists of means to effectuate implicit or explicit decision rules within the target that condition changes in the target on communications received from an external device. Logic 712 effectively determines what, if any, changes will be effectuated in target 700 using communications received from external devices. Logic 712 may be effectuated using any one of several different means either singularly or in combination, such as electronic switches, gate arrays, or microprocessors. Memory 713 can contain data, decision rules, instructions etc. associated with target 700 or activation transaction(s). For example, memory 713 may contain information stored by the manufacturer prior to shipment (e.g. product codes, manufacturing dates and lot codes), received during shipment (e.g. distributor identifiers, routing codes etc.) or received at the time of activation (e.g. date of sale, retailer identifier, activator identifier, consumer information and preferences, usage parameters/options—how many times or how long a target may be used.) etc. Memory 713 may be centralized or distributed (e.g. target ID 716 and target key 717 may be stored in memory storage devices separate from those for storing data received during shipment). Memory 713 may be programmable, writeable, erasable, read-only etc. Memory 713 may be electronic or other forms such as optically readable labels such as bar codes.

Means for effectuating changes 714 may be of one or more types or combinations thereof. Examples include electrical/electronic switches, electro-mechanical locks, programmable/erasable memory, electro-optic thin films etc. and all of the related elements necessary to effectuate the change(s). The operation of means of effectuating changes 714 may be dependent on logic 712. An important aspect of an embodiment of the invention is that to activate a target, it is not necessary for the device transmitting the activation communication(s) to know what activation mechanism is incorporated into the target, how it effectuates the change (s), what change(s) is effectuated or how it affects the target's utility. Power supply 715 provides power to the components of activation mechanisms 710 (e.g. communication means 711, logic 712 etc.). Power supply 715 may be an energy store such as a battery charged prior to shipment by the manufacturer. Power supply 714 may be a means of wirelessly receiving power from an external source such as an antenna that receives RF broadcasts or electromagnetic radiation. Power supply 715 may also be electrical contacts for receiving power from an external source. Power supply 715 may be a combination of different means of acquiring, storing and delivering power to the components of activation mechanisms 710. Power supply 715 should be understood to include the components necessary to provide power in a usable form appropriate to the other components of activation mechanisms 710.

Target ID 716 is associated with activation mechanisms 710 and/or with Target 700. In certain situations Target ID 716 may be comprised of identifiers for both activation mechanisms 710 and target 700. Target ID 716 is typically accessible to external devices (public). Target ID 716 may be unique to activation mechanisms 710 or target 700 (e.g. a serial number) or common to activation mechanisms and targets sharing similar attributes or properties, or belonging to members of the same group or class. Target ID 716 may consist of one or more data stored in memory 713. As such target ID 716 may be stored in one or more different types of memory and one or more locations. Target ID 716 may be stored on or in target 700 or on or in the package containing target 700 (e.g. the box holding a computer). Target ID 716 may or may not be directly coupled or linked to target 700 or activation mechanisms 700. Target key 717 is associated with target ID 716 and is inaccessible to external devices (private) in contrast with target ID 716 which is public. Target key 717 can be stored in memory 713 and may consist of multiple data and/or algorithms etc. necessary to effectuate secure transactions.

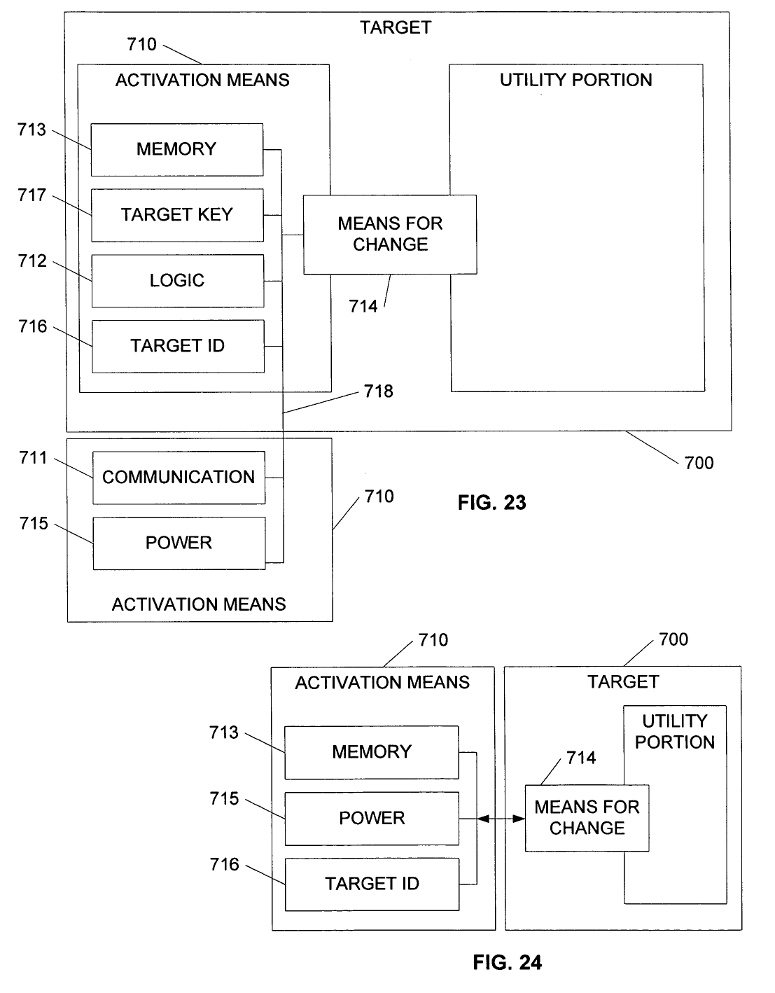

FIG. 23 shows an example of an alternative configuration of activation mechanisms 710. A wireless embodiment of communication means 711 (e.g. RF transmitter/receiver) and power supply 715 is located external to target 700. Logic 712, memory 713, means of effectuating a change 714, target ID 716 and target key 717 located internal to target 700. The internal and external elements are interconnected via connection means 718. Connection means may be wires, ribbon cables etc. and either continuous or coupled at the perimeter of the target (e.g. via a connector that bridges a case housing the target 700.

Alternative configurations such as that shown in FIG. 23 may be necessary for example to activate targets where for example the target's design interferes with wireless communication from an external device. Most consumer electronic products are for example, specifically designed to minimize RF transmissions. To address this problem, the functional elements of an activation mechanisms employing wireless communication means may therefore may be distributed among two or more locations; some internal to the target and others external.

A practical example of the activation mechanisms configured as shown if FIG. 23 is a DVD player (target 700) enhanced with activation mechanisms 710. An electronic switch (means of effectuating a change 714) is incorporated into a circuit (trace) in the DVD's printed circuit board that disconnects the on/off switch from the power supply. When it is shipped from the factory the switch is open, and unless closed the DVD player won't power-up when the switched is turned on. A micro-controller consisting in part of logic 712 and memory 713 is connected to the switch and to a ribbon cable (connection means 718). The ribbon cable terminates in multi-pin (male) jack mounted through the metal case of the DVD player. Plugged into the jack is an RF transceiver and transformer (communication means 711 and power supply 715) capable of receiving data and power from an external RF source. When an RF signal containing data and power is received by the subsystem (group of elements) on the outside of target 700, they are relayed to the internal subsystem which conditionally effectuates the change in the target 700 by closing the switch and thus restoring the DVD player's utility; it will now power-up when the on/off switch is turned on. The combination of a communication means 711 and power supply 715 and connection means 718 (or a part thereof) could be mass produced independent of the other system elements. An advantage of this approach is that each subsystem can be mass produced independent of the other. And further, that the external subsystem can be easily removed.

FIG. 24 shows a diagram of an embodiment of a target 700 and activation mechanisms 710 consisting of memory 713, means of effectuating changes 714, power supply 715 and target ID 716. An example of such a target 700 is an optical disc in a paper sleeve with a printed bar code (memory 713) containing a product code for the DVD (target ID 716). Power supply 715 is an electromagnetic field the DVD is placed within that is appropriate for effectuating a change in an electro-optic film (means of effectuating changes 714) from a first state to a second state. In a first state the electro-optic film prevents an interrogating laser light from a DVD player from accessing the content stored within the DVD. In a second (activated) state, the electro-optic film allows the interrogating laser light of a DVD player to access the content stored within the DVD. Alternatively, an electronic switch could be located on or within the DVD. The electronic switch controls the state of the electro-optic film. The electronic switch can be implemented and controlled in the manner described with the other embodiments disclosed herein.

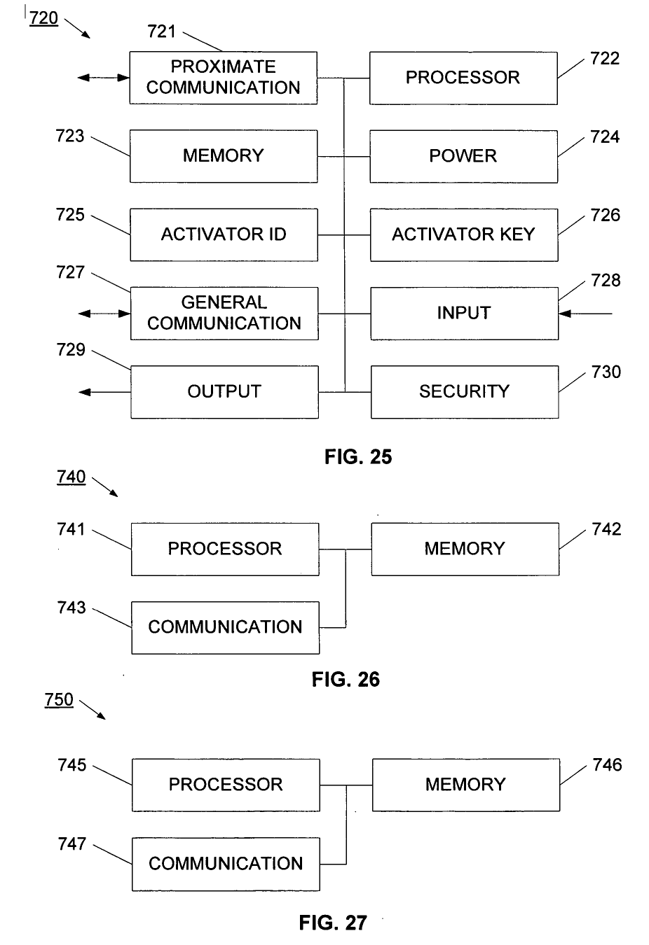

FIG. 25 shows a diagram of an activator 720. Activator 720 is a device for activating target 700; for communicating data and/or power as appropriate with an activation mechanism such as one of the activation mechanisms depicted in FIGS. 1-3; for effectuating decision rules and security; intermediating communication with other devices and systems and activation mechanism 710; enabling interaction with users etc. The functions of activator 720 maybe embodied in a single entity or multiple entities and may be configured differently depending on the application. Activator 720 may also be integrated into, or co-located with another device such as a bar code scanner or other device common to the location where the activation occurs. An activator 720 for a retail check-out counter for example would normally be fixed in place, powered by plugging a plug into 115V AC outlet (in the United States) and communicate via wired connections to a NOC and/or linked systems such as a cash register. An activator 720 for a media/consumer centric application (see below) might however, be mobile, battery operated and communicate wirelessly with a NOC.

Independent of the specific system embodiment (e.g. retail or media/consumer), activator 720 consists of proximate communication means 721, processor 722, memory 723, and power supply 724. Activator 720 may also include one or more of the following:
Identifier (“activator ID”) 725
Activator key 726
General communication means 727
Input means 728
Visual output means 729
Security means 730

Proximate communication means 721 are the means used to communicate data and/or power to activation mechanism 710. Proximate communication means 721 may support one or more wired and wireless methods including but not limited to, IR, UV, RF, electromagnetic, acoustic, inductive electrical (via direct contact) etc. For example electromagnetic radiation may be used to communicate power to activation mechanism 710 while RF is used to transmit and receive data, or a combination of both data and power on the same or different signals. Processor 722 is typically a general purpose microprocessor or an application specific integrated circuit or other device suitable for processing data and instructions. Processor 722 can be shared with another device (as can other elements of the activator) such as a scanner or cash register when the activator 726 is integrated into a point-of-sale system.

Memory 723 is typically electronic and may be programmable, writeable, erasable, read-only etc. Information stored in memory 723 may be temporary or permanent and may include data, decisions rules, instructions etc. associated with activator 720, activation mechanism 720, NOC and linked systems, a transaction etc. For example, memory 723 may contain information stored by the manufacturer prior to shipment (e.g. activator ID 725, activator key 726, product codes, manufacturing dates and lot codes). Memory 723 may also contain information associated with the retailer or store front (e.g. retailer and store front identifiers, retailer specific product/inventory codes etc.). Memory 723 may also contain network and dial-up telephone addresses for communicating with the NOC and linked systems (e.g. cash register or bar code scanner). Memory 723 may also contain target keys. Memory 723 may also contain information associated with transactions (e.g. authorization, activation and verification history, elapsed times etc.). Memory 723 may also contain information received from input means 728 (e.g. card reader, keypad etc.).

Power supply 724 is typically 715V AC (in the United States) although in some applications, such as a media/consumer application (see xyz) power may be supplied by batteries. Activator ID 725 is associated with activator 720 and is typically accessible to external devices (e.g. to activation mechanism 720, the NOC or linked systems). Activator ID 725 may be unique to activator 720 or it may be common to a group or class of devices, for example with other activators belonging to a specific store or retailer. Activator ID 725 is typically stored in electronic memory. Activator key 726 is data stored at activator 720 and is inaccessible to external devices (private) in contrast with activator ID 725 which is typically accessible to external devices (public). Typically activator key 726 is data associated with activator ID 725 and may be stored in activator 720 at the same time as activator ID 725 although it may be stored or changed later. Activator key 726 may also be data associated or specific to a retailer, store, distributor or an external device or system (e.g. an activator).

General communication means 727 are means for communicating with external, and often offsite, devices and systems such as a NOC or linked system(s). General communication means 727 may support local and wide-area wired and/or wireless networks. For example general communication means 726 may support a local area 802.11 wireless network connected to a wide area telecommunications network (e.g. the Internet or virtual private network) to communicate with an off-site NOC.

Input means 728 include any means of receiving input from persons (e.g. customers, users or employees) that have access to activator 720. Examples include keypads, card readers, bio-metric sensors/scanners etc. Inputs received via input means 728 may be stored and/or used by activator 720 to effectuate transactions or they may be communicated to target 700, NOC or linked systems as appropriate. Activator 720 may also have output means 729 to communicate information to persons interacting with activator 720 (e.g. users, customers, employees). Output means 729 may consist in part of one or more devices including LCD's, LED's, CRT's, printers etc.

Activator may also have security means 730 used to effectuate security at activator 720 and in particular to prevent unauthorized access. Security means 730 may be a physical locking mechanism. Security means 730 may be means to determine the geographic location of activator 720 (e.g. GPS transponder). Security means 730 may be conditional communications (e.g. time or signal dependent) with other devices or systems such as a cash register, local area network server or NOC 740.

FIG. 26 shows a diagram of a NOC 740 that is capable of effectuating transactions. NOC 740 is a computer system consisting in part of a processor 742, memory 742 and communication means 743. Typically NOC 740 is located remote from activator 720 and the location where target 740 is activated. NOC 740 however can be located proximate to the activator and activation site (e.g. at a retail store). Further certain capabilities of, or finctions performed by, NOC 740, and in particular storage of target keys 713 may be distributed among various locations and devices (e.g. to a retailer, storefront, point-of-sale system, activator etc.). NOC 740 may receive, store and effectuate transactions using data, decision rules and the like received from various entities including, but not limited to target manufacturers, distributors, retailers, payment processors, consumers etc.; and from various devices and systems such as targets, activators and linked systems. Communications with such entities, devices and systems may be via wired or wireless telecommunications networks.

FIG. 27 shows a diagram of a linked system 750 consisting of processor 745, memory 746, and communication means 747. Linked system 750 may be co-located or proximate activator 720 or remote (offsite). Examples of linked system 750 are a cash register, credit/debit card payment processing system and an inventory system.

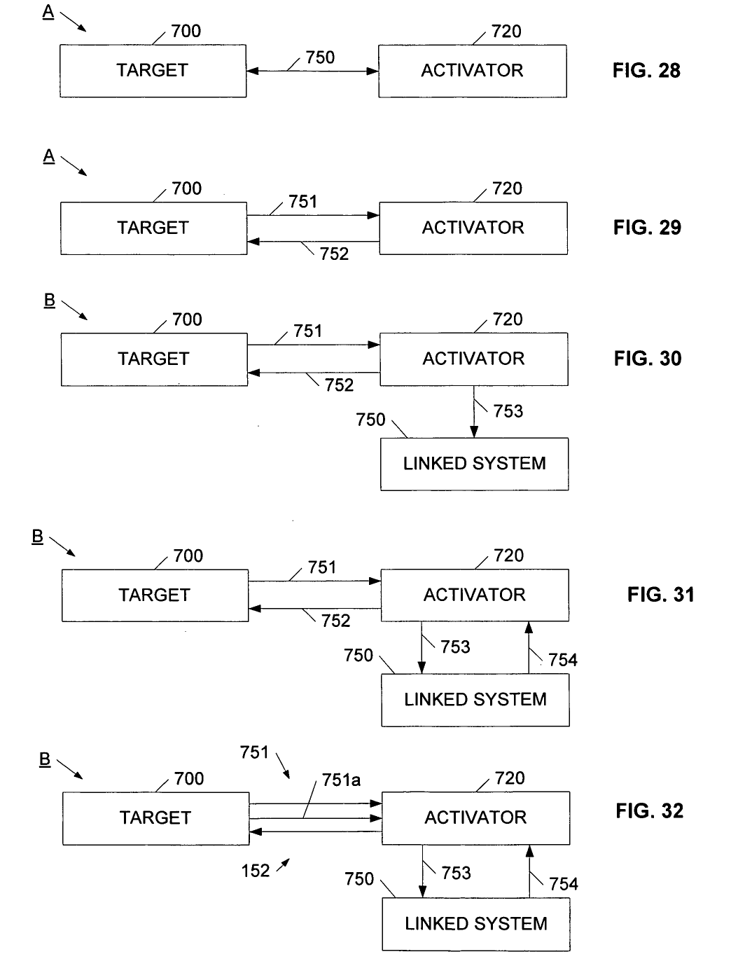

FIG. 28 shows a diagram of a system A that is capable of activating a target 700. System A includes
Target 700 (including an activation mechanism 710);
Activator 720;
Proximate communication 750.

Proximate communication 750 is effectuated between target 700 and activator 720 to communicate data and/or power. Proximate communication 750 may be unidirectional or bidirectional and use one or more wired or wireless methods. Proximate communication 750 may be initiated by either communication means 715 (target 700) or proximate communication means 721 (activator 720). For example proximate communication 750 may be initiated by moving target 700 into the presence of an electromagnetic or RF field, placed in front of an IR sensor or in direct contact with activator 720 (e.g. by electrical or mechanical contact). Proximate communication 750 may also be initiated by proximate communication means 721 by broadcasting an RF signal received by communication means 711 (target 700). Proximate communication 750 may also be initiated by input received by activator 720 from a linked system such as a bar code reader, cash register or media player.

FIG. 29 shows a diagram of a first embodiment of system A that is capable of activating target 700 which includes an activation mechanism 710. An example of a system A is a system where activator 720 receives communication 751 containing target ID 716 which it uses to associate target 700 with data and/or decision rules stored in memory 723. Activator 720 (processor 722) effectuates the decision rules and communicates an appropriate activation signal 752 using proximate communication means 727. Target 700 receives communication 752 using communication means 711. Logic 712 effectuates conditional logic and stored values (memory 713) and appropriately initiates means of effectuating changes 714 which effectuates a change in target 700.

Activator 720 may interrogate target 700 for target ID 716. Alternatively activator 720 may receive target 716 broadcast or otherwise proffered by target 700 via communication means 711. An example of system A is a retail system where only items belonging to a particular retailer can be activated by an activator 720 located within the retailer's stores (in possession of the retailer and proximate the target; a check-out counter inside the retailer's store). In this example, activator 720 receives a communication 751 from target 700 that contains a target ID 716 that can be used to identify target 700 as belonging to a particular retailer (e.g. a retailer code). If activator 720 determines that target ID 716 belongs to the retailer for which activator 720 is authorized to activate, then activator 720 communicates an activation communication (communication 752) containing a retail code. Target 700 receives communication 752 and compares the retail code to values stored in memory 713. If they match, processor logic 712 initiates means of effectuating changes 714 that, for example, closes an electronic circuit enabling target 700 to function normally (restores its utility). In the preceding example power supply 715 could be an internal battery or an external source (e.g. communication 752).

FIG. 30 shows a diagram of a system B that is capable of activating target 700 (having activation mechanism 710) and communicating related information (communication 753) to linked system 750. Communication 753 may contain one or more data and be communicated to one or more linked systems in series or parallel (not shown).

Communication 753 may consist of data associated with target 700 and/or data associated with activator 720 (e.g. activator ID 725). For example communication 753 may contain a target identifier 716 that is received by linked system 750 (e.g. a cash register) to effectuate a financial transaction (i.e. charging a customer for target 700) and update inventory. A particular example would be a communication 753 that emulated a bar code normally read by a bar code scanner. Communication 753 may be dependent on the communication of communication 752 (e.g. an activation signal has been communicated to target 700 prior to communication 753 which is used by linked system 750 to charge a customer), or communication 752 is dependent on communication of communication 753 (e.g. the customer is charged for target 716 before target 700 is activated). Communication 753 may include data associated with the activation of target 700 that is acquired via activator 720 from a source other than target 700 (e.g. an employee identifier or promotional code input via input means 728). Another example of a system B is a system where communication 753 contains formation related to the activation of target 700 that is communicated to a linked system 750 that is a computer system of the manufacturer or distributor of target 700 (e.g. for inventory/production management, auditing etc.).

FIG. 31 shows another diagram of an embodiment of system of B that is capable of activating target 700 (having activation mechanism 710) where the activation communication (communication 752) is dependent on communication 754 from linked system 750. For example, communication 752 may be dependent on activator 720 receiving a signal that a financial transaction has been effectuated by a linked system 750; e.g. a customer has been charged for the purchase of target 700 before it is activated.

Another example of a system B is a system where communication 752 is dependent on activator 720 receiving a communication 754 from linked system 750 (an inventory system) confirming that there is a quantity of target 700 in inventory and available for sale.

Another example of a system B is where target 700 is a restricted item such as an adult movie (e.g. an R rated DVD) or an age-appropriate video game. In this example, linked system 750 receives a communication 753 containing a target ID 716 that it uses to determine if another input (such as an employee identifier and/or customer birth date) is required prior to communicating communication 754. The same conditional logic could be effectuated in activator 720 and the employee inputs obtained at activator 720 or linked system 750 via manual input, card swipe etc. Another example of a system B where changes in target 700 are conditional upon communication 752 (e.g. variables such as the period of time target will be active, the number of times target may be used, the content that can be accessed, the functions that will be activated etc.); where communication 752 is conditional upon variables contained within communication 754.

In addition to activation mechanisms 710, target 700 may also incorporate a mechanism for determining whether an intended change in a target has occurred (e.g. detecting whether a circuit has closed, or by measuring an electrical or optical property of the target.). The mechanism may be contained within the target 700 and communicated to the activator 720. The mechanism may also be distributed between the target 700 and the activator 720 (e.g. a circuit spanning both the target and activator and detected/measured in the activator). The mechanism may be coupled with conditional/Boolean logic in the target (e.g. if a measured value is above a certain threshold then send a signal to the activator, the activator (send confirmation signal to the linked system (cash register) etc. The conditional logic may be effectuated using information (values and/or decision rules etc.) received from the NOC.

FIG. 32 shows a diagram of an embodiment of system B where communication 753 is dependent upon activator 720 receiving a communication 751a (from the mechanism for determining the changeable characteristics of target 700) that verifies that target 700 has been changed (activated). An example is a cash register (linked system 750) receiving a communication 753, dependent on activator 720 receiving an communication 751a verifying that target 700 has been activated, prior to charging a consumer for target 700.

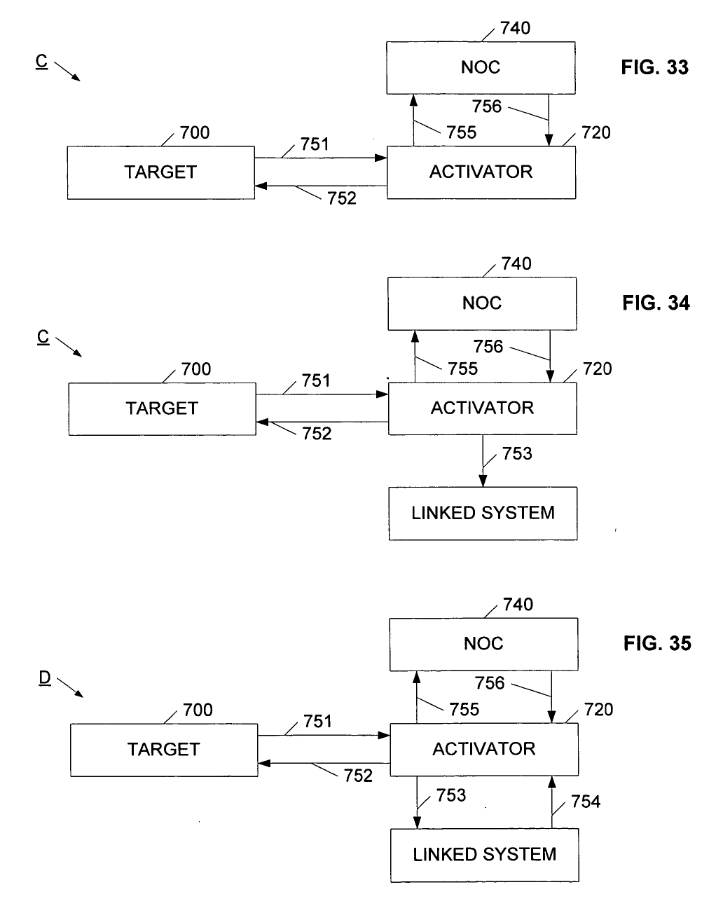

FIG. 33 shows a diagram of a system C that is capable of activating target 700 (having activation mechanism 720) and comprising target 700, activator 720 and NOC 740. An example of a system C is a system where activator 720 receives communication 751 containing target ID 716. Activator 720 communicates communication 755 containing target ID 716 to NOC 740. NOC 740 receives communication 755 and looks up target key 717 via association with target ID 716. NOC 740 communicates communication 756 consisting in part of target key 717 to activator 720. Upon receipt of communication 756, activator 720 communicates an activation communication (communication 752) consisting in part of target ID 713. Target 700 receives communication 752 containing target key 716 which logic 712 uses to activate means for effectuating changes 714 to effectuate changes in target 700. In another example of a system C, the communication 755 contains an activator ID 725 which NOC 740 uses to authenticate activator 720. In another example of a system C, the communication 755 contains inputs from input means 728 (e.g. a user personal identification number or PIN, credit card swipe etc.) that NOC 740 uses to conditionally effectuate communication 756.

FIG. 34 shows a diagram of a system D where communication 753 is conditional on communication 756. For example, communication 756 may include the price to be charged the consumer by linked system 750 (and communicated via activator 720 as communication 753). Communication 753 may be conditional upon communication 756 which is in turn conditional upon an activator ID 725 received via communication 755; e.g. the price to be charged the consumer by linked system 750 is dependent on target 700 and the retailer (associated with activator ID 725).

Communication 756 may include other data specific to target 700 that is used by activator 720 to effectuate a transaction (e.g. the price or cost of target 700 at the time an authorization code (target key 717) is communicated by NOC 740. Communication 753, communication 754, communication 755 and communication 756 may be used individually or in combination to identify, authenticate and/or authorize actuator 720 to prevent its unauthorized use. NOC 740 or linked system 750 for example may effectuate security by methods such as rejecting requests from the activator to participate in a transaction (e.g. supply target keys) if the activator is not identified, authenticated and authorized first. In addition to specific data and algorithms for this purpose (e.g. activator key 726) additional means may be employed such as GPS transmitter/receivers, relative and absolute timed signals etc.).

FIG. 35 shows a diagram of a system D where communication 756 is conditional on communication 754; e.g. communication of target key 716 by NOC 740 is dependent on NOC 740 receiving notification that payment has been made at linked system 750 (via activator 720). In another example of system D, the communication 752 is conditioned on communication 754 and communication 756; e.g. activator 720 only communicates communication 751 upon receipt of both communication 754 and communication 756.

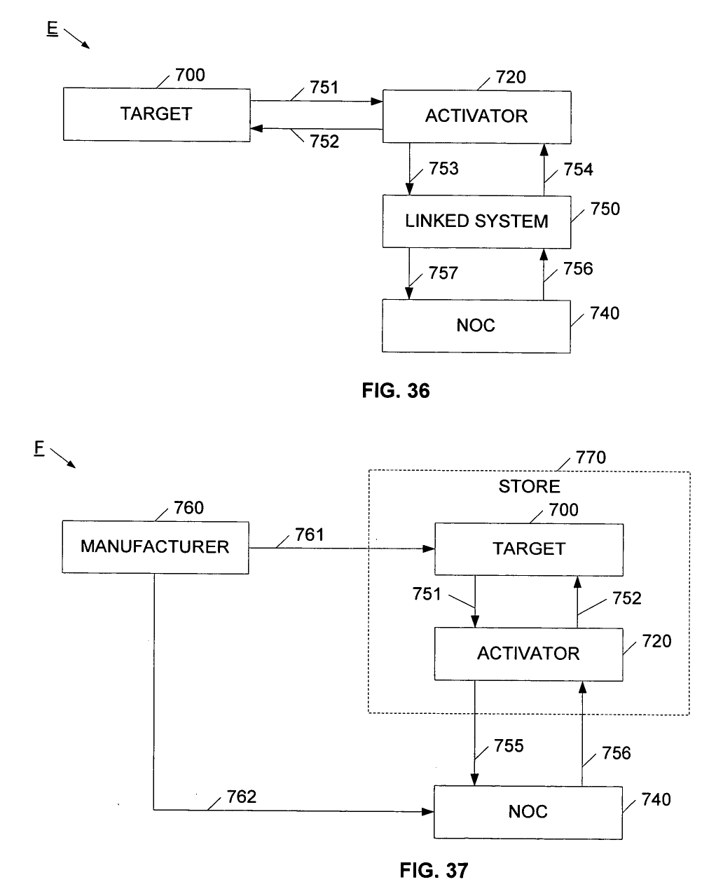

FIG. 36 shows a diagram of a system E where NOC 740 receives communication 757 from linked system 750. Communication 757 may consist of data from target 700 (e.g. target ID 716), activator 720 (e.g. activator ID) and linked system 750 (e.g. notification that payment has been made). Communication 758 may consist of data for linked system 750 (e.g. purchase confirmation, activator 720 (e.g. activator key 726) and target 700 (e.g. target key 717).

FIG. 37 shows a diagram of a system F where target 700 containing target ID 716 and target key 717 is transported (transport 761) from manufacturer 760 to store 770 where it is activated. Manufacturer 760 communicates target ID 716 and target key 717 to NOC 740 via communication 762. Communication 762 typically is via a telecommunications network. To activate target 700 at store 770, the target is placed proximate activator 720 which is communicatively coupled with NOC 740. Via communication 751, activator 720 acquires target ID 716 from target 700 and communicates it to NOC 740 via communication 755. NOC 740 looks up the target key 717 associated with target ID 716 in memory 742 comprised at least in part of information acquired from manufacturer 760 via communication 762. NOC 740 communicates target key 717 via communication 756 to activator 720 which in turn communicates it to target 700 via communication 752. Logic 712 in target 700 compares target key 717 communicated by activator 720 with the target key 717 stored in memory 713, and if they match, logic 712 activates means of effectuating a change 714 which changes target 700 in a way that restores its utility.

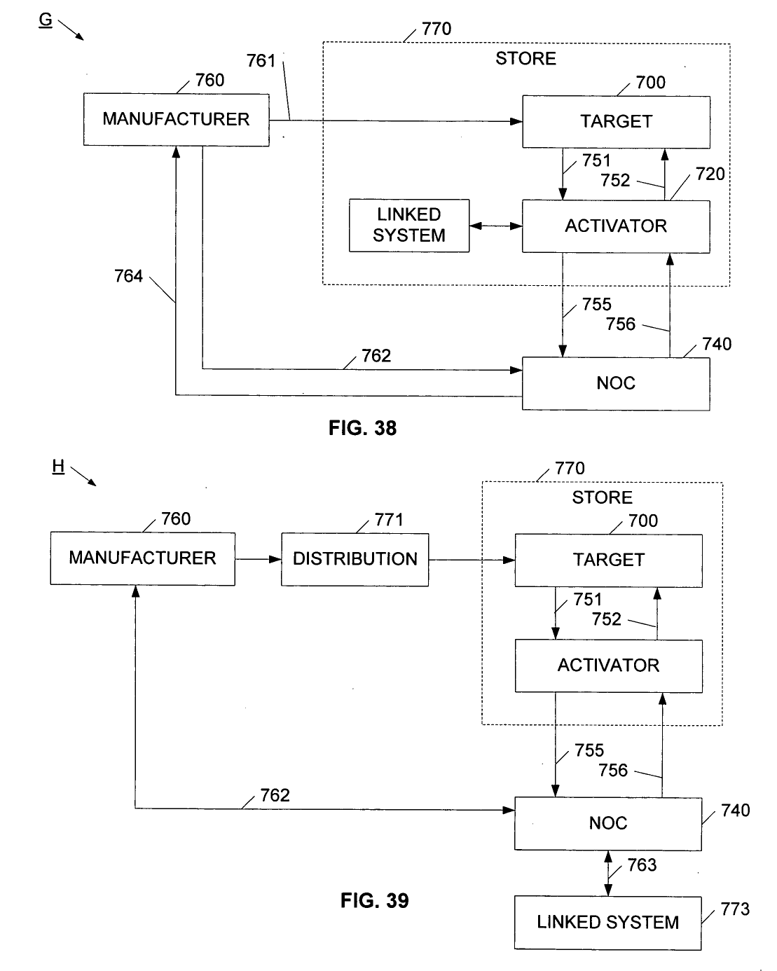

FIG. 38 shows a diagram of a system G which is an expanded implementation of system F and includes a linked system 750 (e.g. cash register) communicatively coupled to activator 720 at store 770, and a communication 764 between NOC 740 and manufacturer 760. Communication 764 may consist of data related to the activation of manufacturer 760's targets.

FIG. 39 shows a diagram of a system a system H where target 700 containing target ID 716 and target key 717 is transported (transport 761) through retail distribution channel 771 from manufacturer 760 to home 772. Retail distribution channel 771 may be comprised of multiple entities and locations as appropriate for different consumer retail models including internet/telephone/mail-order and traditional bricks-and-mortar retailing. System H also includes a linked system 773 communicatively coupled to NOC 773. Linked system 773 may be a computer system of the retailer of target 700 and contain customer information relevant to the activation transaction (e.g. to authorize a purchase) and communicated to NOC via communication 763.

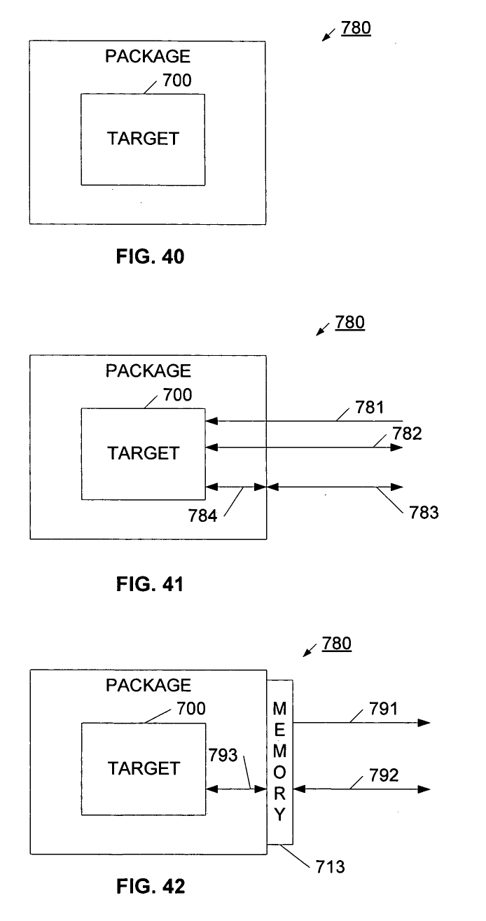

FIG. 40 shows a diagram of target 700 contained within package 780 (e.g. a DVD in a shrink wrapped DVD case; a computer in cardboard box etc.). FIG. 41 shows a diagram of one or more communications involved in bridging or passing through Package 780 and enabling communication (data and/or energy) between Target 700 and external devices. The communications may be a wireless or wired mediums or devices, or a combination of various mediums or devices suitable for relaying data and/or energy including: wire, ribbon cables, clear windows/lenses (visible, IR, UV radiation); RF, acoustic, electromagnetic transmitter/receivers, antennas, rectifiers, energy emitters (e.g. LED's). For example, communication 781 may be via an electromagnetic field capable of transmitting energy wirelessly. Communication 782 may be via RF for wirelessly communicating data and energy wirelessly. Communications 783 & 784 may be data and energy communicated via wires that that employ a means of bridging the package. The communications 783 and 784 may be via different means such as wired/electrical (183) and UV (184), or RF (183) and electrical/wired (184).

FIG. 42 shows a diagram of target 700 contained within a package 780 that includes a distributed element of memory 713 located in or on package 780. Memory 713 in this configuration may include a target ID 716 or other information used to activate target 700 and stored in a form such as a printed bar code or an RFID tag.

The method of communication between an external device and memory 713 may be different than that used for communicating between an external device and directly with target 700. For example an infrared communication 791 (e.g. a barcode scanner) may be used to communicate a target ID from memory 713. Another example would be a memory 713 containing target ID 716 incorporated into an RFID tag embedded in package 780 and accessed via RF communication 792. In the later example, the RFID may be enhanced so that is also capable of bridging communications between an external device and Target 700 using communication Means 793. Communication means 793 may be different than that used for communication 792 between memory 713 and an external device.

Activation mechanisms 710 could be consolidated into a single, mass producible item that complements existing industry standards: an “RFID effector” consisting of
Communication means 711 (RF transceiver)
Logic 712 and memory 713 (microcontroller)
Means of effectuating a change 714: For example, an electronic switch with two output terminals
Power supply 715 (RF transceiver/rectifier)
Target ID 716
Target key 717

The above RFID effector configured into a single unit that could be positioned to bridge a gap in a data or power circuit (e.g. on a printed circuit board with a gap in the trace; each side ending with a solder pad where the output terminals from the means of effectuating a change could be soldered. When the means of effectuating a change are activated (the switch closes) the circuit is completed and target 700's utility is restored.

Alternatively, the means of effectuating a change 714 (the switch) could be part separate from the RFID effector and embedded in the target 700 in an inaccessible or unknowable location (e.g. within the printed circuit board or underneath or behind some part of the target removed from the RFID effector. Upon the right conditions being met (e.g. upon receipt of an appropriate activation communication, the RFID effector would close the switch thus restoring the target's utility.

Different ones of the systems and methods described herein include numerous advantages and differences over previous systems and methods including:
activation is not dependent on the target conditionally initiating the means of activation; and where such means are internal to the target;
activation is not done at the network level, exclusive of changes to the target (e.g. authorizing a credit card or prepaid telephone card);
“activation” is not limited to changing data stored in the target's memory that an external device (such as a computer) or a network (credit card processing) uses to effectuate changes in how the output of the target is used (e.g. the ability to of a DVD player to ‘read’ a DVD is not impaired by encrypting the data; only the DVD player's ability to ‘interpret’ the data);
changes are not made to the target or its means of operation that irreversibly compromise its utility;
changes are not made without prior knowledge of the target (e.g. in response to a deactivation signal, or a generic activation signal (e.g. a Sensormatic security tag); and
the target can be activated in its inoperable state (e.g. without taking it out of the box and plugging it in first).

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A distribution control system, comprising:
a target, further comprising:
a change effecting device configured to affect the utility of the target;
a key stored in memory configured to restrict access to the key;
a receiver configured to receive data; and
logic coupled to the change effecting device, and configured to use the key and received data to selectively switch the change effecting device; and
an activation terminal, further comprising:
access to the data; and
a transmitter for sending the data to the receiver of the target.

2. The distribution control system according to claim 1, wherein the activation terminal accesses the data by retrieving the data from a server.

3. The distribution control system according to claim 1, wherein the activation terminal accesses the data by retrieving the data from a network operation center.

4. The distribution control system according to claim 1, wherein the activation terminal accesses the data by generating the data responsive to other data retrieved from the target.

5. The distribution control system according to claim 1, wherein the activation terminal accesses the data by retrieving the data responsive to other data retrieved from the target.

6. The distribution control system according to claim 1, wherein the receiver for the target and the transmitter for the activation terminal use a wireless communication.

7. The distribution control system according to claim 1, wherein:
the target comprises an accessible identifier; and
the activation terminal comprises a reader for receiving the accessible identifier.

8. The distribution control system according to claim 7, further comprising:
a network operation center having a database that associates a set of accessible identifiers with a set of data;
a network connection between the network operation center and the activation terminal; and
wherein the network operation center receives the accessible identifier from the activation terminal, identifies the data associated with the accessible identifier, and sends the data to the activation terminal.

9. The distribution control system according to claim 8, wherein the activation terminal sends the data to the target.

10. The distribution control system according to claim 1, further comprising:
a network operation center having a database of data; and
a network connection between the network operation center and the activation terminal.

11. The distribution control system according to claim 1, further comprising:
a network operation center having an algorithm for generating the data responsive to other data received from the activation terminal; and
a network connection between the network operation center and the activation terminal.

12. The distribution control system according to claim 1, further comprising:
the activation terminal further comprises a terminal identifier;
a network operation center having a database of data and a set of authorized activation terminals;
a network connection between the network operation center and the activation terminal;
wherein the network operation center receives the terminal identifier from the activation terminal and sends the data to the activation terminal only if the terminal identifier identifies the activation terminal as one from the set of authorized activation terminals.

13. The distribution control system according to claim 1, further comprising:
the activation terminal further comprises a security identifier;
a network operation center having a database of data and a set of authorized activation terminals, each activation terminal having an associated approved security list;
a network connection between the network operation center and the activation terminal;
wherein the network operation center receives the security identifier from the activation terminal and sends the data to the activation terminal only if the security identifier is within the approved security list for the activation terminal.

14. The distribution control system according to claim 13, wherein the security identifier is an absolute time signal, a periodic time signal, a handshaking signal, a position location information, or a communication address.

15. The distribution control system according to claim 1, wherein the activation terminal further comprises a payment verifier for confirming receipt of payment from a consumer.

16. The distribution control system according to claim 1, wherein the activation terminal further comprises:
a link to a remote server;
communication means for receiving a message from the remote server; and
wherein the activation terminal sends the data to the target responsive to the received message.

17. The distribution control system according to claim 16, wherein the data is stored on the remote server.

18. The distribution control system according to claim 16, wherein the data is stored on a server different than the remote server.

19. The distribution control system according to claim 16, wherein the activation terminal is in a local facility the remote server is also in the local facility.

20. The distribution control system according to claim 16, wherein the activation terminal is in a local facility the remote server is in a different facility.

21. The distribution control system according to claim 16, wherein the communication means requests, responsive to receiving the message from the remote server, the data from another server.

22. The distribution control system according to claim 16, wherein the communication means requests, responsive to receiving the message from the remote server, the data from the remote server.

23. The distribution control system according to claim 16, further comprising:
the communication means further configured to send an authorization request message to the remote server, and
wherein the received message indicates that authorization has been confirmed.

24. The distribution control system according to claim 23, wherein the authorization message is a message to request payment authorization, to request membership authorization, to request password authorization, or to request a personal code authorization.

25. The distribution control system according to claim 23, wherein the authorization request is a request for check, credit card, check card, or debit card payment authorization, and the received message is a confirmation that payment was authorized.

26. The distribution control system according to claim 1, wherein the activation terminal further comprises an input device for receiving authorization information from a consumer.

27. The distribution control system according to claim 1, wherein the target is a tangible media, and the change effecting device is an electrically switchable optical material.

28. The distribution control system according to claim 27, wherein the tangible media is one selected from the group consisting of: tickets, coupons, vouchers, credit cards product labels and tags, security devices, memory cards, removable computer storage, optical discs, DVD, CD, and game cartridge.

29. The distribution control system according to claim 1, wherein the target is an electronic device.

30. The electronic device according to claim 19, wherein the electronic device selected from the group consisting of: computer; game console; integrated circuit chip; processor; camera; television; phone; PDA (personal data/digital assistant); calculator; portable music, video, or game player; electronically controlled appliance or tool; watch; printer; fax machine; machinery, instrument; and computer peripheral.

31. The distribution control system according to claim 1, wherein the change effecting device is a mechanical, electronic, power, electrical, electromechanical, or logical switch, or is a value in a memory location.

32. The distribution control system according to claim 1, wherein the target is an integrated circuit device, and the change effecting device is a fuse, electrical, or logical switch.

33. A target, comprising:
an externally perceptible indicia that indicates the target has controlled utility; and
the target configured with controlled utility.

34. The target according to claim 33, wherein the indicia is constructed with a change effectuating device so that the indicia indicates how the utility is currently controlled.

35. The target according to claim 33, wherein the indicia indicates the target is unusable.

36. The target according to claim 33, wherein the utility of the target is compromised until the target is activated.

37. The target according to claim 33, wherein the target is an electronic device.

38. The target according to claim 33, wherein the target is a tangible media.

39. The target according to claim 33, wherein the target is an optical disc.

40. A package, comprising:
an externally perceptible indicia that indicates a target has controlled utility;
the target configured with controlled utility, and is in the package; and
wherein the indicia is on the packaging.

41. A method for distributing an electronic device, comprising:
receiving an electronic device with a utility controlled to be in a first utility state;
transferring the controlled electronic device to another party;
confirming that the other party is authorized to use the electronic device in a second utility state ; and
controlling the utility of the electronic device to the second utility state.

42. The method according to claim 41, wherein:
the first state is a compromised utility; and
the controlling step includes restoring the compromised utility to the electronic device.

43. The method according to claim 41, wherein:
the first state is a restored utility; and
the controlling step includes compromising the restored utility of the electronic device.

44. The method according to claim 41, further comprising:
displaying the controlled electronic device at a retail location; and
selling the controlled electronic device to a consumer.

45. The method according to claim 44, further including: confirming payment by the consumer; and controlling the utility of the electronic device responsive to confirming payment.

46. The method according to claim 42, wherein the compromised electronic device is a compromised computer, a compromised game console, a compromised integrated circuit chip, a compromised processor, a compromised camera, a compromised television, a compromised phone, a compromised PDA, a compromised calculator, a compromised portable music player, a compromised watch, or a compromised computer peripheral.

47. The method according to claim 44, wherein the retail location is a retail store, and the controlling step is performed at a point-of-sale terminal in the retail store.

48. The method according to claim 44, wherein the retail location is an on-line store, and the controlling step is performed at a consumer location.

49. The method according to claim 44, wherein the retail location is a consumer location, and the controlling step is performed at the consumer location.

50. A method for distributing media, comprising:
receiving media compromised to control how an intended reader is able to read the media;
transferring the compromised media to another party;
confirming that the other party is authorized to have the compromised media in a restored state where the compromised media would be able to be read in the intended reader; and
sending data to the compromised media according to how the compromised media is to be restored.

51. The method according to claim 50, further comprising:
displaying the compromised media at a retail location;
selling the comprised media to a consumer; and
confirming payment by the consumer.

52. The method according to claim 51, wherein sending the data to the compromised media is done responsive to confirming the payment.

53. The method according to claim 51, wherein the retail location is a retail store, and the sending step is performed at a point-of-sale terminal in the retail store.

54. The method according to claim 51, wherein the retail location is an on-line store, and the sending is performed at a consumer location.

55. The method according to claim 51, wherein the retail location is a consumer location, and the sending step is performed at the consumer location.

56. The method according to claim 50, wherein the compromised media is a tangible media, an optical disc, a DVD, a CD, or a game cartridge.

57. A method for controlling distribution of a target, comprising:
having a set of predefined keys that includes a predefined key capable of affecting a utility of the target;
receiving an identifier value;
retrieving the predefined key that is associated with the received identifier value; and
sending the predefined key.

58. The method according to claim 57, further including the step of authorizing the target to have its utility affected prior to sending the predefined key.

59. The method according to claim 57, further including the step of determining that an activation terminal is authorized to affect the utility of the target prior to sending the predefined key.

60. The method according to claim 58, wherein the authorizing step includes confirming payment for the target.

61. The method according to claim 58, wherein the authorizing step includes confirming an authorization password, code, or input from a purchaser of the target.

62. The method according to claim 57 further including the step of receiving confirmation that the target has had its utility affected.

63. The method according to claim 62, further including the step of authorizing payment to an entity in the distribution chain responsive to receiving the confirmation.

64. The method according to claim 62, further including the step of reporting the confirmation to an entity in the distribution chain responsive to receiving the confirmation.

65. The method according to claim 57, wherein the target is an electronic device, optical disc, or tangible media.

66. A point of sale device for effecting a change in the utility of a target, comprising:
means to provide an authorized key; and
a transmitter for sending the authorized key to the target.

67. The point of sale device of claim 66, further comprising:
a reader for reading an accessible identifier from the target; and
wherein the means to provide an authorized key further comprises means to associate the authorized key with the accessible identifier read from the target.

68. The point of sale device of claim 66, wherein reader and the transmitter use wireless communication.

69. The point of sale activation device of claim 66, further comprising:
a reader; and
wherein the reader is constructed to read a confirmation value from the target to confirm that the target effected a change in utility responsive to receiving the authorized key.

70. The point of sale activation device of claim 66, further comprising:
a receiver; and
wherein the receiver is constructed to receive a confirmation value transmitted from the target that confirms that the target effected a change in utility responsive to receiving the authorized key.

71. The point of sale device of claim 66, wherein the transmitter is constructed to send other data information to the target.

72. The point of sale device of claim 66, further including an input device for receiving authorization information from a consumer.

73. The point of sale device of claim 66, further including:
an input device for receiving utility selection information; and
wherein the authorization key is selected to effect the utility according to the selection.

74. The point of sale device of claim 66, further including an input device for receiving payment from a consumer.

75. The point of sale device of claim 66, wherein the transmitter uses wireless communication.

76. The point of sale device of claim 66, wherein the means to provide an authorized key includes a network connection to a network operation center.

77. The point of sale device of claim 76, wherein the means to provide an authorized key includes a database of authorized keys stored at the network operation center.

78. The point of sale device of claim 66, wherein the means to provide an authorized key includes a database of authorized keys stored locally at the point of sale device.

79. The point of sale device of claim 66, wherein the means to provide an authorized key includes a connection to a remote server.

80. The point of sale device of claim 79, wherein the means to provide an authorized key includes a database of authorized keys stored at the remote server.

81. The point of sale device of claim 80, wherein the point of sale terminal is in a local facility the remote server is also in the local facility.

82. The point of sale device of claim 80, wherein the point of sale terminal is in a local facility and the remote server is in a different facility.

83. The point of sale device of claim 66, wherein the means to provide an authorized key includes an algorithmic process to generate the authorized key locally.

84. The point of sale device of claim 66 wherein the means to provide an authorized key includes an algorithmic process to generate the authorized key remotely.

85. A distribution control system, comprising:
a target having a utility intentionally compromised before entering its distribution chain;
an authorization key transmittable to the target responsive to an authorized condition; and
wherein the authorization key is selected to effectuate a change in the compromised utility of the target.

86. The distribution control system according to claim 85, wherein the target stores a restricted-access key that is equivalent to the authorization key.

87. The distribution control system according to claim 85, wherein the target stores a restricted-access key that is determined from the authorization key.

88. The distribution control system according to claim 85, wherein the target stores a restricted-access key and the target uses the restricted-access key and the authorization key to effectuate the change.

89. The distribution control system according to claim 85, wherein the target stores a restricted-access key and the target compares the authorization key to the restricted access key prior to effectuating the change.

90. The distribution control system according to claim 85, wherein the authorized condition is confirmation of payment at a point of sale terminal in a retail store.

91 The distribution control system according to claim 85, wherein the target is an optical disc, and the authorization key causes a change in an electrically switchable optical material on the optical disc.

92. The distribution control system according to claim 85, wherein the target is a tangible media, and the authorization key causes an optically perceptive change on the tangible media.

93. The distribution control system according to claim 85, wherein the target is an electronic device, and the authorization key causes a change in a mechanical, electrical, electronic, electromechanical, or logical switch.

94. The distribution control system according to claim 85, wherein the target is an integrated circuit device, and the authorization key causes a change in a fuse, electrical, or logical switch.

95. The distribution control system according to claim 85, wherein the utility is the ability for the target or a component of the target to power on.

96. The distribution control system according to claim 85, wherein the utility is the ability for the target or a component of the target to complete its initialization cycle.

97. The distribution control system according to claim 85, wherein the utility is an aesthetic appeal of the target.

98 The distribution control system according to claim 85, wherein the utility is the ability for the target or a component or subsystem of the target to function properly.

99. A method of manufacturing a target, comprising:
installing a change effecting device with the target so that in one state a utility of the target is compromised and in another state the utility is not compromised;
setting the change effecting device to one of the states;
storing a restricted-access key with the target;
configuring a receiver with the target to receive an authorization key; and
configuring logic to use the authorization key and the restricted-access key to change the state of the change effecting device to the other state.

100. The method of manufacturing according to claim 99, further comprising:
storing a plurality of restricted-access keys with the target; and
configuring the logic to use the authorization key and one of the restricted access keys to change the state of the change effecting device.

101. The method of manufacturing according to claim 99, further comprising:
installing a plurality of change effecting devices with the target, each change effecting device configured to effect a different utility;
configuring the logic to use the authorization key and the restricted-access key to change the state of at least one of the change effecting devices to the other state.

102. The method of manufacturing according to claim 101, further comprising:
installing a plurality of change effecting devices with the target, each change effecting device configured to effect a different utility;
configuring the logic to use the authorization key and the restricted-access key to change the state of at least two of the change effecting devices to the other state.

103. The method of manufacturing according to claim 99, further comprising the step of providing an accessible identification value with the target.

104. The method of manufacturing according to claim 99, further comprising the step of generating a file that associates identification values with keys.

105. The method of manufacturing according to claim 99, wherein the target is a tangible media, and the change effecting device is an electrically switchable optical material.

106. The method of manufacturing according to claim 105, wherein the tangible media is one selected from the group consisting of: tickets, coupons, vouchers, credit cards product labels and tags, security devices, memory cards, removable computer storage, optical discs, DVD, CD, and game cartridge.

107. The method of manufacturing according to claim 99, wherein the target is an electronic device.

108 The method of manufacturing according to claim 107, wherein the electronic device selected from the group consisting of: computer; game console; integrated circuit chip; processor; camera; television; phone; PDA (personal data/digital assistant); calculator; portable music, video, or game player; electronically controlled appliance or tool; watch; printer; fax machine; machinery, instrument; and computer peripheral.

109. The method of manufacturing according to claim 99, further including the step of:
providing an indicia that indicates the target has controlled utility; and
affixing the indicia to be externally perceptible.

110. The method of manufacturing according to claim 109 wherein the indicia is a label on the target.

111. The method of manufacturing according to claim 109 wherein the indicia is a label on packaging for the target.

112. A method for controlling the utility of a target, comprising:
authorizing a target to have its utility affected;
requesting an authorization key capable of affecting the authorized utility on the target;
sending the authorization key.

113. The method for controlling the utility of a target according to claim 112, wherein the authorizing step includes receiving a confirmation message from a remote server.

114. The method for controlling the utility of a target according to claim 113, wherein the confirmation message is a message confirming payment; a message confirming a passcode; a message confirming membership; or a message confirming biometric security data.

115. The method for controlling the utility of a target according to claim 112, further including the step of receiving the authorization key from a remote server.

116. The method for controlling the utility of a target according to claim 1 12, wherein the requesting step includes receiving an identification value associated with the target.

117. The method for controlling the utility of a target according to claim 1 12:
wherein the requesting step includes sending an identification value to a remote server; and
further including the step of receiving the authorization key from the remote server.

118. The method for controlling the utility of a target according to claim 1 12:
wherein the requesting step includes sending an identification value to a remote server; and
further including the step of receiving the authorization key from the another remote server.

119. The method for controlling the utility of a target according to claim 112:
wherein the requesting step includes receiving an identification value; and
generating the authorization key.

120. The method for controlling the utility of a target according to claim 112, further including the step of:
receiving a confirmation message that the target has had its utility affected.

121. The method for controlling the utility of a target according to claim 120, further including the step of:
including the information regarding the confirmation messages in a report.

122. The method for controlling the utility of a target according to claim 120, further including the step of:
using the confirmation messages to generate a payment.

123. A method of controlling theft at a retail store, comprising:
offering electronic devices for sale that when placed in an operating state are configured to have a commercially unusable utility.

124. The method of controlling theft at a retail store according to claim 123, further comprising the step of restoring the electronic device to a commercially usable utility at a point of sale.

125. The method of controlling theft at the retail store according to claim 123, wherein the electronic device is selected from the group consisting of: a computer; a game console; an integrated circuit chip; a processor; a camera;a television; a phone; a PDA (personal data/digital assistant); a calculator; a portable music, video, or game player; an a electronically controlled appliance or tool; a watch; a printer; a fax machine; a machinery, an instrument; and a computer peripheral.

126. A method of controlling theft at a retail store, comprising:
accepting delivery of electronic devices that when placed in an operating state are configured to have a commercially unusable utility.

127. The method of controlling theft at a retail store according to claim 126, further comprising the step of restoring the electronic device to a commercially usable utility after accepting delivery.

128. The method of controlling theft at a retail store according to claim 127, wherein the restoring step is performed prior to placing the electronic devices in inventory; prior to shelving the electronic devices; or at a point of sale terminal as the electronic device is sold.

129. A method of controlling theft at a retail store:
offering unreadable optical discs for sale.

130. The method of controlling theft at the retail store according to claim 124, wherein the unreadable optical discs are DVDs, CDs, or game discs.

131. An anti-theft kit, comprising:
a target having at least one of its desired utilities controlled; and
an indicia positioned such that it is externally readable, the indicia communicating that the target is controllable.

132. An anti-theft kit, comprising:
a package comprising a target having at least one of its desired utilities controlled; and
an indicia positioned on the package such that it is externally readable, the indicia communicating that the target is controllable.
